(19) United States
(12) Patent Application Publication
(10) Pub. No.: US 2006/0103637 A1
(43) Pub. Date: May 18, 2006

(54) Inputting/outputting apparatus and method, recording medium, and program

(75) Inventors: Kazunori Yamaguchi, Kanagawa (JP); Tsutomu Harada, Kanagawa (JP); Mitsuru Tateuchi, Kanagawa (JP); Motoshige Okada, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/254,786

(22) Filed: Oct. 21, 2005

(30) Foreign Application Priority Data
Oct. 29, 2004 (JP) P2004-315729

(51) Int. Cl. G09G 5/00

(52) U.S. Cl. 345/175

(57) ABSTRACT

An inputting/outputting apparatus and method is disclosed wherein the position of an object which is in contact with or in the proximity of the apparatus can be detected with a high degree of accuracy with a simple structure without deteriorating the picture quality while the convenience in use is assured. Each pixel of a display section includes a display cell and a light reception cell. Emission of light of the display cell is controlled so that it blinks by a number of times per unit time corresponding to the number of frames per unit time. Reception of light by the light reception cells is controlled such that the amount of light incoming to all light reception cells is acquired within one light emission period and also within one no-light emission period. The invention can be applied to an image display apparatus.

### CROSS REFERENCES TO RELATED APPLICATIONS

The present invention contains subject matter related to Japanese Patent Application JP 2004-315729 filed in the Japanese Patent Office on Oct. 29, 2004, the entire contents of which being incorporated herein by reference.

### BACKGROUND OF THE INVENTION

This invention relates to an inputting/outputting apparatus and method, a recording medium and a program, and more particularly to an inputting/outputting apparatus and method, a recording medium and a program wherein an image can be displayed and an instruction can be inputted by an operation of a user.

Several apparatus for detecting the position and so forth of an object which is in contact with or in the proximity of a display apparatus are conventionally known. As a representative one of such apparatus, a display apparatus which includes a touch panel is spread widely.

Although various types of touch panels are available, a resistance film type touch panel, an infrared ray blocking type touch panel, an electromagnetic induction type touch panel and a touch panel of the type which detects an electrostatic capacitance are spread widely. In the touch panel of the type which detects an electrostatic capacitance, a variation of surface charge of the panel caused by a finger touching with the touch panel is detected, and the position of an object (the finger) is detected from the variation of surface charge. Consequently, the user can operate the touch panel intuitively.

Further, in recent years, also various apparatus have been proposed which do not include such a touch panel as described above but detect the position or the like of an object with respect to a display apparatus to allow the user to operate the apparatus intuitively.

For example, Japanese Patent Laid-Open No. Hei 11-149348 (hereinafter referred to as Patent Document 1) discloses an infrared ray type finger inputting pointer apparatus. In the apparatus disclosed in Patent Document 1, a light emitting element and a light receiving element of infrared rays are disposed at one end of a planar pad having a surface along which a finger can move such that pointer control can be performed only by moving a finger on the planar pad.

### SUMMARY OF THE INVENTION

However, it is necessary for the apparatus of Patent Document 1 to include an inputting apparatus and so forth separately from the display apparatus. Therefore, the apparatus of Patent Document 1 has a subject to be solved in that an increased number of parts increases the cost of the product and the apparatus cannot be operated intuitively by the user when compared with a display apparatus which includes a touch panel.

Also a display apparatus which includes a touch panel requires an increased number of parts because the touch panel must be provided on a display screen and hence requires an increased cost. Further, the display apparatus which includes a touch panel has a subject to be solved also in that, when light from the display screen passes through the touch panel, it is changed by the touch panel, resulting in deterioration of the picture quality.

Further, in the case of the touch panels of the resistance film type and of the electrostatic capacitance detection type which are spread-widely as described above, it is possible to detect the position of only one point on the display screen at a time. Therefore, the touch panels have a subject in that they are not very convenient in use to a user.

In short, the conventional apparatus described above have a subject to be solved in that it is difficult to detect presence of an object which is in contact with or in the proximity of the apparatus or the position of an object which is in contact with or in the proximity of the apparatus with a simple structure without deteriorating the picture quality while the convenience in use is assured.

It is an object of the present invention to provide an inputting/outputting apparatus and an inputting/outputting method for an inputting/outputting apparatus wherein presence of an object which is in contact with or in the proximity of the apparatus or the position of an object which is in contact with or in the proximity of the apparatus can be detected with a high degree of accuracy with a simple structure without deteriorating the picture quality while the convenience in use is assured.

In order to attain the embodiment described above, according to an embodiment of the present invention, there is provided an inputting/outputting apparatus wherein a plurality of display elements for displaying an image in a predetermined number of frames per unit time and a plurality of light receiving elements individually provided corresponding to the display elements are arranged on a screen, including a light emission control section for controlling emission of light of the display elements so that the display elements blink by a number of times per unit time which corresponds to the number of frames per unit time, and a light reception control section for controlling reception of light by the light receiving elements so that the amount of light incoming to all of the light receiving elements within one light emission period within which the display elements emit light is acquired and the amount of light incoming to all of the light receiving elements within one no-light emission period within which the display elements emit no light is acquired.

According to another embodiment of the present invention, there is provided an inputting/outputting method for an inputting/outputting apparatus wherein a plurality of display elements for displaying an image in a predetermined number of frames per unit time and a plurality of light receiving elements individually provided corresponding to the display elements are arranged on a screen, including a light emission control step of controlling emission of light of the display elements so that the display elements blink by a number of times per unit time which corresponds to the number of frames per unit time, and a light reception control step of controlling reception of light by the light receiving elements so that the amount of light incoming to all of the light receiving elements within one light emission period within which the display elements emit light is acquired and the amount of light incoming to all of the light receiving elements within one no-light emission-period within which the display elements emit no light is acquired.

According to a further embodiment of the present invention, there is provided a recording medium on which a computer-readable program for an inputting/outputting process of an inputting/outputting apparatus wherein a plurality of display elements for displaying an image in a predetermined number of frames per unit time and a plurality of light receiving elements individually provided corresponding to the display elements are arranged on a screen is recorded, the program including a light emission control step of controlling emission of light of the display elements so that the display elements blink by a number of times per unit time which corresponds to the number of frames per unit time, and a light reception control step of controlling reception of light by the light receiving elements so that the amount of light incoming to all of the light receiving elements within one light emission period within which the display elements emit light is acquired and the amount of light incoming to all of the light receiving elements within one-no-light emission period within which the display elements emit no light is acquired.

According to a still further embodiment of the present invention, there is provided a program for causing a computer of an inputting/outputting apparatus wherein a plurality of display elements for displaying an image in a predetermined number of frames per unit time and a plurality of light receiving elements individually provided corresponding to the display elements are arranged on a screen to execute an inputting/outputting process, including a light emission control step of controlling emission of light of the display elements so that the display elements blink by a number of times per unit time which corresponds to the number of frames per unit time, and a light reception control step of controlling reception of light by the light receiving elements so that the amount of light incoming to all of the light receiving elements within one light emission period within which the display elements emit light is acquired and the amount of light incoming to all of the light receiving elements within one no-light emission period within which the display elements emit no light is acquired.

In the inputting/outputting apparatus and method, recording medium and program, emission of light of the display elements is controlled so that the display elements blink by a number of times per unit time which corresponds to the number of frames per unit time. Further, reception of light by the light receiving elements is controlled so that the amount of light incoming to all of the light receiving elements within one light emission period within which the display elements emit light is acquired and the amount of light incoming to all of the light receiving elements within one no-light emission period within which the display elements emit no light is acquired.

With the inputting/outputting apparatus and method, recording medium and program, it is possible to display an image and detect the position of an object.

Further with the inputting/outputting apparatus and method, recording medium and program, presence of an object which is in contact with or in the proximity of the apparatus or the position of an object which is in contact with or in the proximity of the apparatus can be detected with a high degree of accuracy with a simple structure without deteriorating the picture quality while the convenience in use is assured.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of an image display apparatus to which the present invention is applied;

FIG. 2 is a schematic view showing a configuration of a display section of the image display apparatus;

FIG. 3 is a circuit diagram showing a circuit configuration of a displaying light receiving cell of the display section;

FIGS. 4 to 9 are diagrammatic views illustrating operations for detecting presence of an object which is in contact with or in the proximity of the display section;

FIG. 10 is a diagrammatic view illustrating a manner of scanning of a displaying selection signal;

FIG. 11 is a diagrammatic view illustrating a scanning manner of the displaying selection signal, a reset signal and a reading out signal;

FIG. 12 is a diagrammatic view illustrating a period of time within which charge generated by reception of light by a light reception cell is accumulated;

FIG. 13 is a diagrammatic view illustrating display time;

FIG. 14 is a flow chart illustrating a scanning control process;

FIGS. 15 and 16 are diagrammatic views each illustrating a reset signal and a reception light signal;

FIG. 17 is a diagrammatic view illustrating another scanning-manner of a displaying selection signal, a reset signal and a reading out signal;

FIG. 18 a flow chart illustrating another scanning control process;

FIGS. 19 to 22 are diagrammatic views illustrating different scanning manners of a displaying selection signal, a reset signal and a reading out signal;

FIG. 23 is a flow chart illustrating a light emission control process of a backlight source;

FIG. 24 is a flow chart illustrating a further scanning control process;

FIGS. 25 and 26 are diagrammatic views illustrating further different scanning manners of a displaying selection signal, a reset signal and a reading out signal;

FIG. 27 is a flow chart illustrating a still further scanning control process;

FIG. 28 is a diagrammatic view illustrating a further different scanning manner of a displaying selection signal, a reset signal and a reading out signal;

FIG. 29 is a flow chart illustrating a yet further scanning control process;

FIG. 30 is a view illustrating differences among different embodiments of the present invention;

FIG. 31 is a schematic view showing an example of a plurality of backlight sources;

FIG. 32 is a diagrammatic view illustrating a still further different scanning manner of a displaying selection signal, a reset signal and a reading out signal; and

FIG. 33 is a flow chart illustrating a yet further scanning control process.

### DESCRIPTION OF THE PREFERRED EMBODIMENTS

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

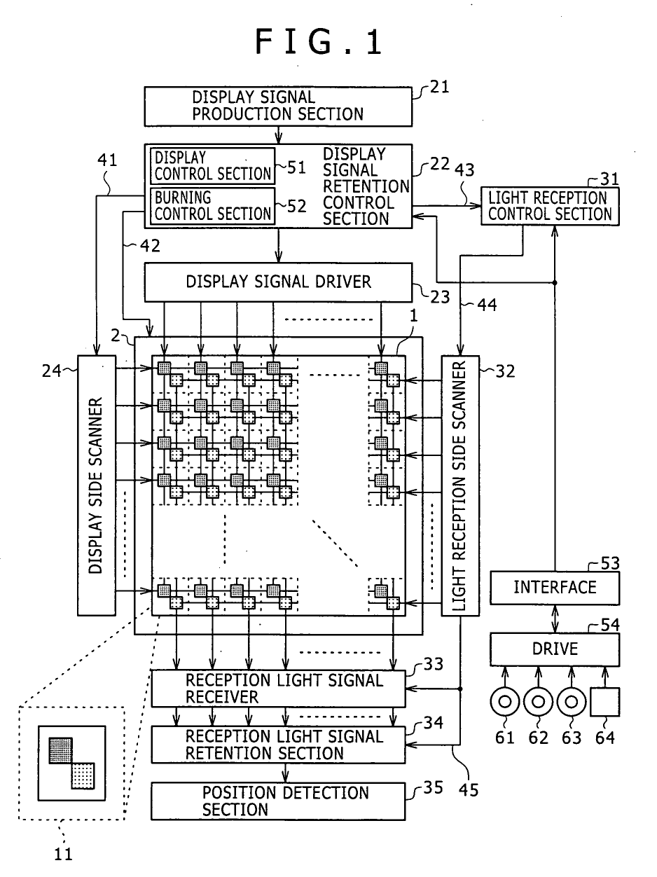

According to the invention as set forth in claim 1, there is provided an inputting/outputting apparatus wherein a plurality of display elements (for example, display cells CW of FIG. 1) for displaying an image in a predetermined number of frames per unit time and a plurality of light receiving elements (for example, light caption cells CR of FIG. 1) individually provided corresponding to the display elements are arranged on a screen, including a light emission control section (for example, a lighting control section 52 of FIG. 1) for controlling emission of light of the display elements so that the display elements blink by a number of times per unit time which corresponds to the number of frames per unit time, and a light reception control section (for example, a light reception control section 31 of FIG. 1) for controlling reception of light by the light receiving elements so that the amount of light incoming to all of the light receiving elements within one light emission period within which the display elements emit light is acquired and the amount of light incoming to all of the light receiving elements within one no-light emission period within which the display elements emit no light is acquired.

The light emission control section may control emission of light of a backlight (for example, a backlight source 2 of FIG. 1) to control the emission of light of the display elements.

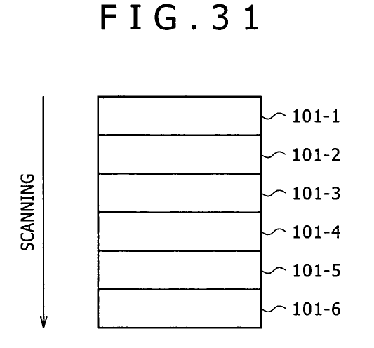

The light emission control section may control emission of light of a plurality of backlights (for example, backlight sources 101-1 to 191-6 of FIG. 31) disposed in accordance with an order of operation of the display elements which operate line sequentially on the screen so that the backlights are turned on to emit light to control the emission of light of the display section.

The inputting/outputting apparatus may further include a display control section (for example, a display control section 51 of FIG. 1) for controlling the display by the display elements so that the display of the display element is updated only within a light emission period within which the display elements emit light.

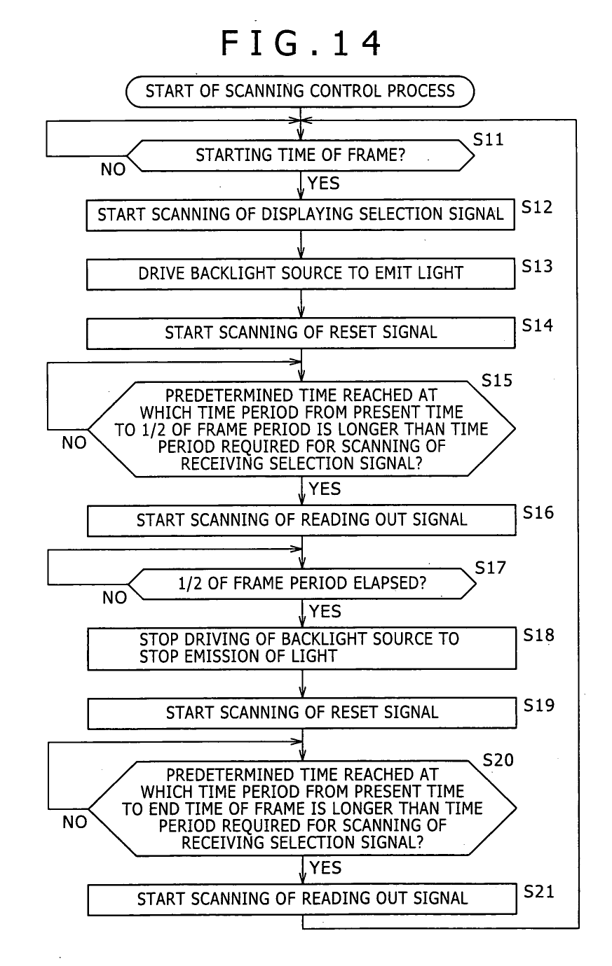

According to the invention as set forth in claim 7, an inputting/outputting method for an inputting/outputting apparatus wherein a plurality of display elements (for example, display cells CW of FIG. 1) for displaying an image in a predetermined number of frames per unit time and a plurality of light receiving elements (for example, light caption cells CR of FIG. 1) individually provided corresponding to the display elements are arranged on a screen, including a light emission control step (for example, processes at steps S14 and S18 of FIG. 14) of controlling emission of light of the display elements so that the display elements blink by a number of times per unit time which corresponds to the number of frames per unit time, and a light reception control step (for example, processes at steps S16 and S21 of FIG. 14) of controlling reception of light by the light receiving elements so that the amount of light incoming to all of the light receiving elements within one light emission period within which the display elements emit light is acquired and the amount of light incoming to all of the light receiving elements within one no-light emission period within which the display elements emit no light is acquired.

According to the invention as set forth in claim 9, a program for causing a computer of an inputting/outputting apparatus wherein a plurality of display elements (for example, display cells CW of FIG. 1) for displaying an image in a predetermined number of frames per unit time and a plurality of light receiving elements (for example, light caption cells CR of FIG. 1) individually provided corresponding to the display elements are arranged on a screen to execute an inputting/outputting process, including a light emission control step (for example, processes at steps S14 and S18 of FIG. 14) of controlling emission of light of the display elements so that the display elements blink by a number of times per unit time which corresponds to the number of frames per unit time, and a light reception control step (for example, processes at steps S16 and S21 of FIG. 14) of controlling reception of light by the light receiving elements so that the amount of light incoming to all of the light receiving elements within one light emission period within which the display elements emit light is acquired and the amount of light incoming to all of the light receiving elements within one no-light emission period within which the display elements emit no light is acquired.

The program may be recorded on a recording medium (for example, a magnetic disk 61 of FIG. 1).

FIG. 1 shows a configuration of an image display apparatus to which the present invention is applied.

Referring to FIG. 1, the image display apparatus includes a display section 1, a backlight source 2, a display signal production section 21, a display signal retention control section 22, a display signal driver 23, and a display side scanner 24. The image display apparatus further includes a light reception control section 31, a light reception side scanner 32, a reception light signal receiver 33, a reception light signal retention section 34 and a position detection section 35.

The display section 1 may be, for example, an organic or inorganic EL (electroluminescence) display unit, an LCD (Liquid Crystal Display) unit, an FED (Field Emission Display) unit, a PDP (Plasma Display Panel) or the like wherein a plurality of pixels 11 are disposed in a matrix over an overall display area. The display section 1 performs line sequential action as hereinafter described to display an image including a predetermined figure, characters and so forth. Each of the pixels 11 of the display section 1 is formed from a displaying light receiving cell CWR having a display cell CW including one display element and a light reception cell CR including a light receiving element such that displaying action and light receiving action can be performed for each one pixel as hereinafter described.

The backlight source 2 is formed from, for example, an LED (Light Emitting Diode) or an organic or inorganic EL element and emits light. The light emitted from the backlight source 2 enters the display section 1 and passes through the display section 1 to form an image.

It is to be noted that, where the display section 1 is formed from a spontaneous light emitting element such as an organic or inorganic EL display panel, the backlight source 2 and a lighting control section 52 hereinafter described are unnecessary. Further, the backlight source 2 may be any light source only if the responding speed when it lights and unlights is so high that the timings of lighting and unlighting can be controlled, and not only an LED or an EL element but also a cold-cathode tube can be used for the backlight source 2.

The display signal production section 21 produces a display signal for displaying a screen (frame), for example, for each one screen (one frame) based on data produced by a CPU (Central Processing Unit) or the like and supplied thereto from the CPU. The display signal production section 21 supplies the produced display signal to the display signal retention control section 22.

The display signal retention control section 22 stores and retains the display signal supplied thereto from the display signal production section 21 for each one screen (one frame) into and in a frame memory formed from, for example, an SRAM (Static Random Access Memory). The display signal retention control section 22 controls action of the display side scanner 24 and the display signal driver 23 which drive the display cells CW. More particularly, the display signal retention control section 22 supplies a display timing control signal 41 indicating a displaying timing and supplies, based on the display signal stored in the frame memory, a display signal for a horizontal one line to the display signal driver 23 to control action of the display side scanner 24 and the display signal driver 23 for driving the display cells CW.

Further, the display signal retention control section 22 supplies a vertical synchronizing signal 43 indicative of a timing of a frame to the light reception control section 31 to control an operation timing of the light reception control section 31 which controls a light receiving action of the entire display section 1. Further, the display signal retention control section 22 supplies a signal representative of whether or not the backlight source 2 is lit to the light reception control section 31 to control the operation timing of the light reception control section 31 which controls a light receiving operation of the entire display section 1. Or, the display signal retention control section 22 supplies a signal representative of whether or not scanning of a displaying selection signal (hereinafter described) of the entire display section 1 is completed to the light reception control section 31 thereby to control the operation timing of the light reception control section 31 which controls the light receiving operation of the entire display section 1.

Further, the display signal retention control section 22 supplies a lighting timing control signal 42 to the backlight source 2 to control the timing of light emission of the backlight source 2.

The display signal driver 23 supplies display data to the display cells CW of an object of driving in response a display signal for one horizontal line outputted from the display signal retention control section 22. More particularly, the display signal driver 23 supplies a voltage corresponding to the display data to a pixel 11 selected by the display side scanner 24 through a data supplying line connected to each pixel 11 of the display section 1.

The display side scanner 24 selects a display cell CW of an object of driving in response to the display timing control signal 41 outputted from the display signal retention control section 22. More particularly, the display side scanner 24 supplies a displaying selection signal through a displaying gate line connected to each pixel 11 of the display section 1 to control a display element selection switch hereinafter described. In other words, when a displaying selection signal of a voltage with which the display element selection switch of a predetermined pixel is placed into an on state is applied from the display side scanner 24, then the pixel performs a displaying action corresponding to the voltage supplied thereto from the display signal driver 23.

Where the display side scanner 24 and the display signal driver 23 operate cooperatively to perform a line sequential operation in this manner, an image corresponding to arbitrary display data is displayed on the display section 1.

The light reception control section 31 supplies a light reception timing control signal 44 to the light reception side scanner 32 based on the vertical synchronizing signal 43 supplied thereto from the display signal retention control section 22. Further, the light reception control section 31 supplies the light reception timing control signal 44 to the light reception side scanner 32 based on a signal supplied thereto from the display signal retention control section 22 and representative of whether or not the backlight source 2 is lit. Or, the light reception control section 31 supplies the light reception timing control signal 44 to the light reception side scanner 32 based on the signal supplied thereto from the display signal retention control section 22 and representative of whether or not scanning of a displaying selection signal of the entire display section 1 is completed.

The light reception side scanner 32 selects a light reception cell CR of an object of driving in response to the light reception timing control signal 44 outputted from the light reception control section 31. The light reception side scanner 32 supplies a light reception selection signal to each pixel 11 of the display section 1 through a light receiving gate line connected to the pixel 11 to control the light receiving element selection switch of the pixel 11. In particular, similarly to the operation of the display side scanner 24, if a light reception selection signal of a voltage with which the light receiving element selection switch is placed into an on state is applied from the light reception side scanner 32 to a predetermined pixel 11, then the pixel 11 outputs a light reception signal corresponding to the amount of light detected by the pixel 11 to the reception light signal receiver 33.

Consequently, the light reception cell CR can receive the light and acquire the light reception signal representative of the amount of detected light.

Further, the light reception side scanner 32 outputs a light reception block control signal 45 to the reception light signal receiver 33 and the reception light signal retention section 34 thereby to control the reception light signal receiver 33 and the reception light signal retention section 34.

It is to be noted that, in the image display apparatus of the present embodiment, the displaying gate line and the light receiving gate line described hereinabove are connected separately from each other to each displaying light receiving cell CWR, and the display side scanner 24 and the light reception side scanner 32 operate independently of each other.

The reception light signal receiver 33 acquires the light reception signal for one horizontal line outputted from the light reception cells CR in response to the light reception block control signal 45 outputted from the light reception side scanner 32. The light reception signals for one horizontal line acquired by the reception light signal receiver 33 are outputted to the reception light signal retention section 34.

The reception light signal retention section 34 re-constructs the light reception signal outputted from the reception light signal receiver 33 into a light reception signal for each one screen (for each display of one frame) in accordance with the light reception block control signal 45 outputted from the light reception side scanner 32. Then, the reception light signal retention section 34 stores and retains the re-constructed reception light signal into and in a frame memory formed from, for example, an SRAM or the like. The data of the reception light signal stored in the reception light signal retention section 34 are outputted to the position detection section 35.

It is to be noted that the reception light signal retention section 34 may be formed from a storage element other than a memory and, for example, the data of the reception light signal may be retained as analog data.

The position detection section 35 performs signal processing based on the data of the reception light signal outputted from the reception light signal retention section 34 to specify the position at which an object detected by the light reception cells CR exists. By the process, it is possible to specify the position of an object which is in contact with or is positioned in the proximity of the backlight source 2.

It is to be noted that, where the reception light signal retention section 34 has the data of the reception light signal stored as analog data therein, the position detection section 35 executes the signal processing after it performs analog/digital conversion (hereinafter referred to as A/D conversion).

Further, the display signal retention control section 22 includes a display control section 51 and a lighting control section 52. The display control section 51 controls the display side scanner 24 and the display signal driver 23 to control driving of the display cells CW of the display section 1. The lighting control section 52 produces a lighting timing control signal 42 to control lighting and unlighting of the backlight source 2.

A drive 54 is connected to the backlight source 2 through an interface 53 as occasion demands, and reads out a program recorded on a magnetic disk 61, an optical disk 62, a magneto-optical disk 63 or a semiconductor memory 64 loaded therein and supplies the read out program to the display signal retention control section 22 and the light reception control section 31. The display signal retention control section 22 and the light reception control section 31 execute a program recorded on and read out from the magnetic disk 61, optical disk 62, magneto-optical disk 63 or semiconductor memory 64 each of which is an example of a recording medium.

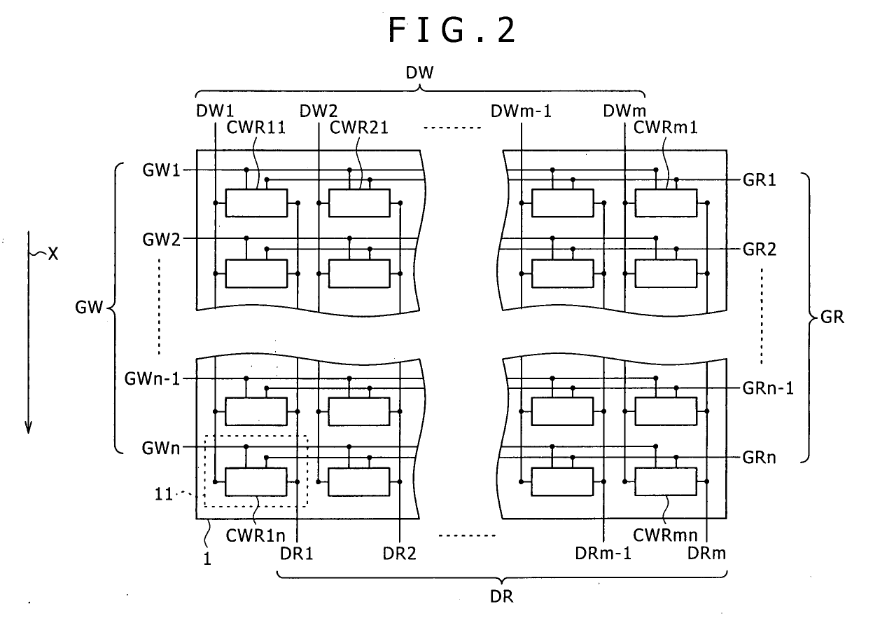

FIG. 2 shows an example of a configuration of the display section 1 shown in FIG. 1. It is to be noted that the display section 1 is formed from totaling m×n pixels 11 arranged in a matrix of m columns and n rows. Here, if the display section 1 complies with the XGA (extended Graphics Array) standards which are popular standards, for example, in personal computers (PCs), totaling 2,359,296 pixels where m=1,024×3 (RGB) and n=768 are arrayed in a matrix.

Referring to FIG. 2, the display section 1 includes totaling m×n pixels 11 including m×n displaying light receiving cells CWR11 to CWRmn, and m data supplying lines DW (DW1 to DWm) and m data reading out lines DR (DR1 to DRm) and n displaying gate lines GW (GW1 to GWn) and n light receiving gate lines GR (GR1 to GRn) connected in accordance with the number of pixels 11.

The data supplying lines DW, data reading out lines DR, displaying gate lines GW and light receiving gate lines GR are connected to the display signal driver 23, reception light signal receiver 33, display side scanner 24 and light reception side scanner 32 described hereinabove, respectively, and a display signal, a displaying selection signal and a reception light selection signal are supplied to each of the displaying light receiving cells CWR while a reception light signal is outputted from each of the displaying light receiving cells CWR. Further, as seen in FIG. 2, a data supplying line DW, a data reading out line DR, a displaying gate line GW and a light receiving gate line GR are connected to each of the displaying light receiving cells CWR. Further, for example, the data supplying line DW1 and the data reading out line DR1 are connected commonly to the displaying light receiving cells CWR11, CWR12, . . . , CWR1n along one vertical line, and for example, a displaying gate line GW and a light receiving gate line GR are connected commonly to the displaying light receiving cells CWR11, CWR21, . . . , CWRm1 along one horizontal line. It is to be noted that an arrow mark X in FIG. 2 indicates a scanning direction of the displaying gate lines GW and the light receiving gate lines GR as hereinafter described.

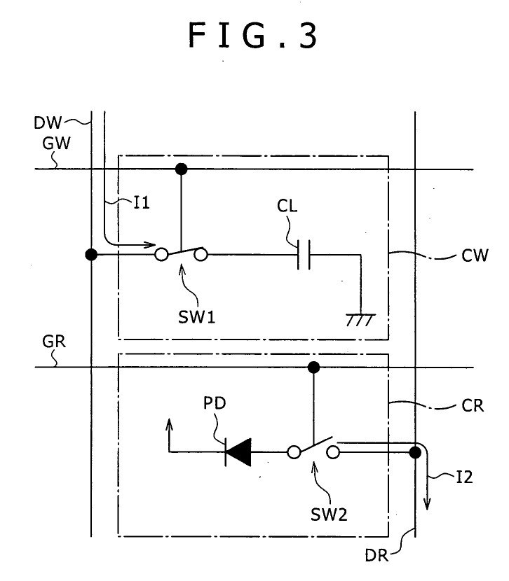

FIG. 3 shows a circuit configuration of a displaying light receiving cell CWR shown in FIG. 2.

Referring to FIG. 3, the displaying light receiving cell CWR includes one display cell CW and one light reception cell CR. A displaying gate line GW and a data supplying line DW are connected to the display cell CW while a light receiving gate line GR and a data reading out line DR are connected to the light reception cell CR. In other words, for the displaying light receiving cell CWR, a gate line and a data line for light reception are additionally provided when compared with an ordinary cell for one pixel which includes only a display cell.

Meanwhile, the display cell CW includes a display cell CL and a display element selection switch SW1 for selectively connecting the data supplying line DW and one terminal of the display cell CL in response to a displaying selection signal supplied thereto from the displaying gate line GW. One terminal of the display element selection switch SW1 is connected to the data supplying line DW while the other terminal of the display element selection switch SW1 is connected to one terminal of the display cell CL. The other terminal of the display cell CL is grounded.

The light reception cell CR includes a light receiving element PD and a light receiving element selection switch SW2. The light receiving element PD is formed from a photodiode and generates charge in accordance with the intensity of received light.

One terminal of the light receiving element selection switch SW2 is connected to one terminal of the data reading out line DR while the other terminal of the light receiving element selection switch SW2 is connected to one terminal of the light receiving element PD. The light receiving element selection switch SW2 selectively connects the terminal of the light receiving element PD and the data reading out line DR in accordance with the light receiving selection signal supplied thereto from the light receiving gate line GR. The other terminal of the light receiving element PD is either grounded or connected to a positive bias point (not shown).

When the one terminal of the light receiving element PD and the data reading out line DR are in a disconnected state by the light receiving element selection switch SW2, if the light receiving element PD is illuminated with light, then the light receiving element PD generates charge in response to the intensity of the received light and accumulates the generated charge. If the one terminal of the light receiving element PD and the data reading out line DR are connected to each other by the light receiving element selection switch SW2, then the charge accumulated in the light receiving element PD is outputted from the light receiving element PD to the data reading out line DR.

It is to be noted that the circuit configuration of the displaying light receiving cell CWR can perform a displaying action and a light receiving action independently of each other because the gate lines for display and light reception are connected separately from each other as described hereinabove.

Here, action of the components upon displaying action and light receiving action are described particularly. First, upon displaying action, the display element selection switch SW1 is placed into an on state in response to the displaying selection signal supplied thereto from the displaying gate line GW in such a manner as described above, and the display element CL is charged from the data supplying line DW along a path indicated by reference character I1 in FIG. 3 so that it passes therethrough light from the backlight source 2 having a luminance according to the display signal to perform displaying action. On the other hand, the light receiving element selection switch SW2 is placed into an on state in accordance with the light receiving selection signal supplied thereto from the light receiving gate line GR in such a manner as described above, and current is supplied to the data reading out line DR along another path indicated by reference character I2 in accordance with the amount of light received by the light receiving element PD to perform light receiving action (reading out action). It is to be noted that, when none of such displaying action and light receiving action as mentioned above is performed, both of the display element selection switch SW1 and the light receiving element selection switch SW2 are in an off state, and the data supplying line DW and the data reading out line DR are disconnected from the display cell CL and the light receiving element PD, respectively.

In the following, action of an object which is in contact with or in the proximity of the display section 1 of the image display apparatus having such a configuration as described above is described. The object here may be part of the body of the user or a thing.

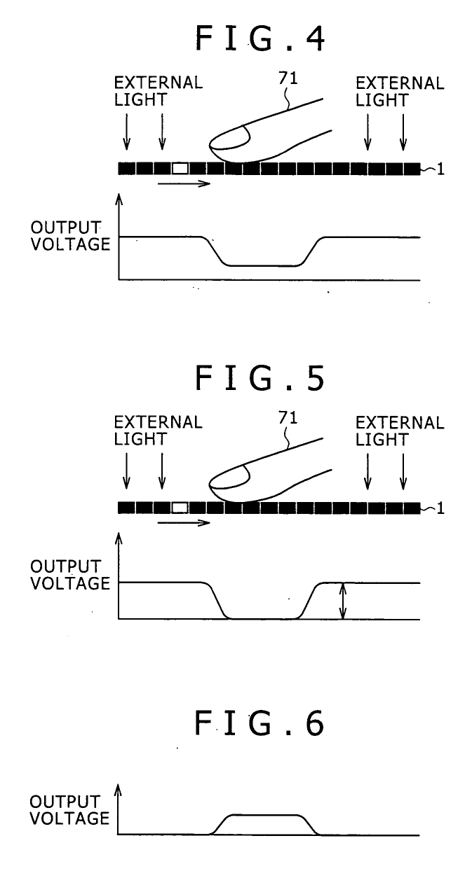

FIGS. 4 to 9 illustrate action of detecting an object which is in contact with or in the proximity of the display section 1. In an upper portion of each of FIGS. 4, 5, 7 and 8, the display section 1 and an example of an object which is in contact with or in the proximity of the display section 1 are shown, and in a lower portion of each of FIGS. 4, 5, 7 and 8, an example of a reception light signal when the object is in contact with or in the proximity of the display section 1 is shown. In FIGS. 4, 5, 7 and 8, the horizontal direction is the horizontal line direction or the vertical line direction.

Referring first to FIG. 4, when the backlight source 2 emits light, the light emitted from the backlight source 2 is illuminated, for example, on a finger 71 of a user which points to a position on the display section 1 through the display section 1. Reflected light of the light illuminated on the finger 71 of the user which is an example of an object which is in contact with or in the proximity of the display section 1 enters the display section 1. The light reception cells CR of the display section 1 receive both of the reflected light reflected from the finger 71 of the user and external light incoming from the outside and outputs a reception light signal representative of the amount of the received light.

In particular, when the backlight source 2 emits light, the light reception cells CR of the display section 1 output a reception light signal representative of the total amount of the reflected light emitted from the display section 1 and reflected by the finger 71 of the user and the external light.

On the other hand, when the backlight source 2 does not emit light, since no light is illuminated from the image display apparatus as seen in FIG. 5, the light reception cells CR of the display section 1 receive only external light incoming from the outside and outputs a reception light signal representative of the amount of the received light.

If the reception light signal when the backlight source 2 does not emit light is subtracted for each of the light reception cells CR from the reception light signal when the backlight source 2 emits light, then a reception light signal representative of the amount of the reflected light reflected by the finger 71 of the user as seen from FIG. 6 can be obtained. For example, the position detection section 35 subtracts, for each light reception cell CR, the reception light signal when the backlight source 2 does not emit light from the reception light signal when the backlight source 2 emits light and detects the position of the finger 71 of the user from the reception light signal obtained in this manner and representing the amount of the reflected light reflected by the finger 71 of the user.

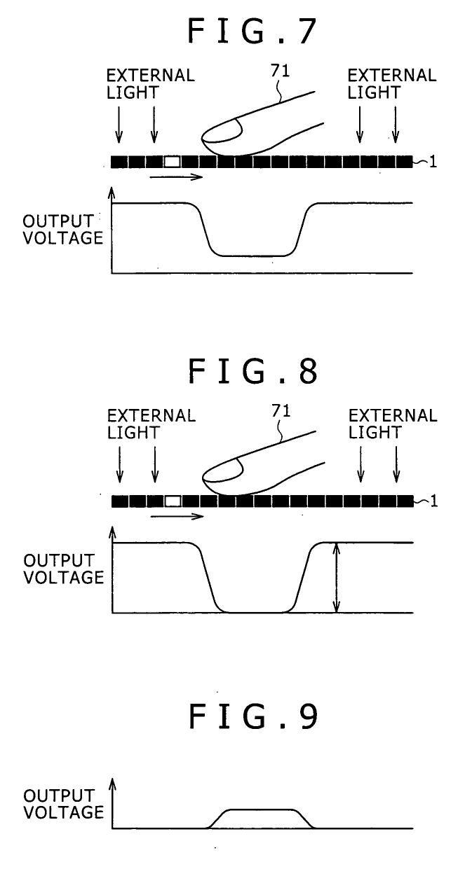

FIGS. 7 and 8 illustrate action of detecting an object which is in contact with or in the proximity of the display section 1 when the external light is more intense than that in the case described above with reference to FIGS. 4 to 6.

Referring to FIG. 7, when the backlight source 2 emits light, the light emitted from the backlight source 2 is illuminated, for example, on a finger 71 of a user which points to a position on the display section 1 through the display section 1. Reflected light of the light illuminated on the finger 71 of the user enters the display section 1. The light reception cells CR of the display section 1 receive the reflected light reflected from the finger 71 of the user and further receives more intense external light incoming from the outside, and outputs a reception light signal representative of the amount of the received light.

When the backlight source 2 emits light, each of the light reception cells CR of the display section 1 outputs a reception light signal representative of the total amount of the reflected light emitted from the image display apparatus and reflected by the finger 71 of the user and the more intense external light.

In this instance, the level of the reception light signal corresponding to the external light illustrated in FIG. 7 is higher than the level of the reception light signal corresponding to the external light illustrated in FIG. 4.

On the other hand, when the backlight source 2 does not emit light, since no light is illuminated from the image display apparatus as seen in FIG. 8, each of the light reception cells CR of the display section 1 receives only the more intense external light incoming from the outside and outputs a reception light signal representative of the amount of the received light.

In this instance, the level of the reception light signal corresponding to the external light illustrated in FIG. 8 is higher than the level of the reception light signal corresponding to the external light illustrated in FIG. 5.

However, since the level of the reception light signal corresponding to the external light illustrated in FIG. 8 is equal to the level of the reception light signal corresponding to the external light illustrated in FIG. 7, if the reception light signal of FIG. 8 when the backlight source 2 does not emit light is subtracted for each of the light reception cells CR from the reception light signal of FIG. 7 when the backlight source 2 emits light, then a reception light signal representative of the amount of the reflected light reflected by the finger 71 of the user is obtained as seen from FIG. 9.

The reception light signal obtained by subtracting the reception light signal of FIG. 8 when the backlight source 2 does not emit light from the reception light signal of FIG. 7 when the backlight source 2 emits light is equal to the reception light signal illustrated in FIG. 6.

In this manner, the fact that an object is in contact with or in the proximity of the display section 1 or the position of an object which is in contact with or in the proximity of the display section 1 can be detected with a higher degree of accuracy without being influenced by the intensity of external light. Further, presence of a plurality of objects in contact with or in the proximity of the display section 1 can be detected at the same time, and a plurality of positions of a plurality of objects which are in contact with or in the proximity of the display section 1 can be detected at the same time.

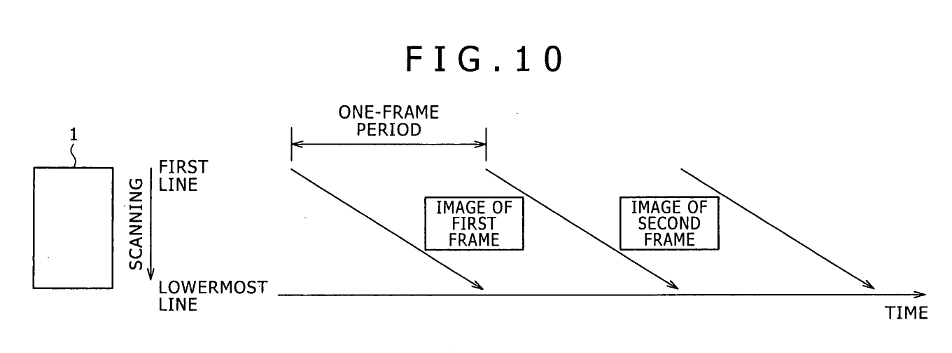

FIG. 10 illustrates scanning of the displaying selection signal when presence of an object which is in contact with or in the proximity of the display section 1 is not detected. The vertical direction of FIG. 10 indicates a scanning line direction along which the displaying selection signal is scanned on the display section 1. The horizontal direction of FIG. 10 indicates the time.

The display section 1 displays (an image of) a frame for each frame period which is a period within which one frame is to be displayed. For example, where 60 frames are displayed for one second, the one-frame period is 1/60 second.

After a frame period starts, the display side scanner 24 supplies a displaying selection signal successively to the pixels 11 in order from above of the display section 1 to change the display of the display cells CW of the pixels 11. In particular, at a stating point of time of a frame period, the display side scanner 24 supplies the displaying selection signal to the display cells CW of the pixels 11 through the displaying gate line GW1 and then successively supplies the displaying selection signal in order to the display cells CW of the pixels 11 through the displaying gate line GW2 to the displaying gate line GWn.

The display cell CW of each of the pixels 11 to which the displaying selection signal is supplied passes the light from the backlight source 2 which has a luminance according to a display signal. Accordingly, when the displaying selection signal is supplied to the display cells CW of the pixels 11 through the displaying gate lines GW1 to GWn, the display section 1 displays an image of one frame.

This action is repeated for each frame period, and for individual one-frame periods, an image of the first frame, another image of the second frame, a further image of the third frame and so forth are successively displayed until an image of the nth frame is displayed.

If presence of an object which is in contact with or in the proximity of the display section 1 is not detected, then the backlight source 2 continues to emit light.

Now, detection of presence of an object which is in contact with or in the proximity of the display section 1 is described.

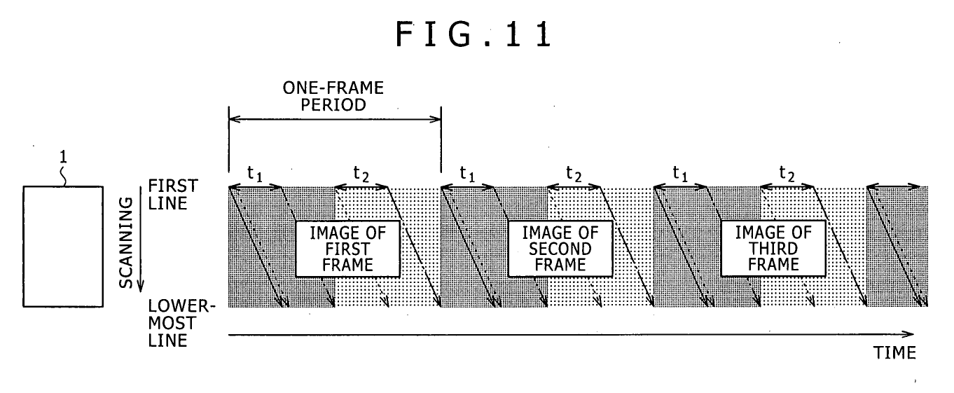

First, a first embodiment of the present invention is described with reference to FIGS. 11 to 24.

When presence of an object which is in contact with or in the proximity of the display section 1 is to be detected, the backlight source 2 can be turned on to emit light and receive light and then turned off to receive light for each frame period. The period within which the backlight source 2 is on to emit light and the period within which the backlight source 2 is off to stop the light emission can each be set to ½ the frame period.

It is to be noted that, in order to make the luminance of the display section 1 fixed, it is necessary to set the luminance of the backlight source 2 where the period within which the backlight source 2 is on to emit light and the period within which the backlight source 2 is off to stop the light emission are both set to ½ the frame period to twice that of the backlight source 2 where the backlight source 2 continues to emit light.

FIGS. 11 to 13 illustrate scanning of the displaying selection signal where presence of an object which is in contact with or in the proximity of the display section 1 is detected. The vertical direction of FIGS. 10 to 13 indicates a vertical line direction along which the displaying selection signal is scanned on the display section 1. The horizontal direction of FIGS. 11 to 13 indicates the time.

When presence of an object which is in contact with or in the proximity of the display section 1 is to be detected, the lighting control section 52 of the display signal retention control section 22 causes the backlight source 2 to blink. For example, the lighting control section 52 controls, for each frame period, the backlight source 2 to emit light from a starting point of time of the frame period to a point of time at which ½ the frame period elapses and to stop the light emission from the point of time at which ½ the frame period elapses to an ending point of time of the frame period.

In FIGS. 11 to 13, a densely dotted portion indicates a period within which the backlight source 2 emits light, and a coarsely dotted portion indicates another period within which the backlight source 2 does not emit light.

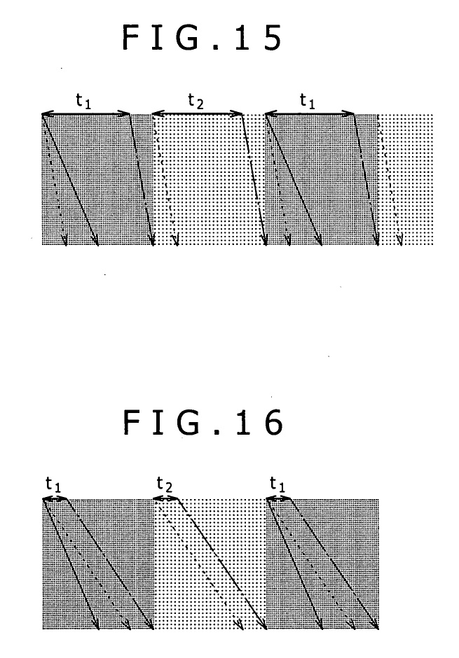

It is to be noted that, also in FIGS. 15 to 17, 19 to 22, 25, 26 and 28, a densely dotted portion indicates a period within which the backlight source 2 emits light, and a coarsely dotted portion indicates another period within which the backlight source 2 does not emit light similarly.

After a frame period starts, the display side scanner 24 changes the display of the display cells CW of all of the pixels 11 of the display section 1 within a period of ¼ the frame period. For example, where the frame period is 1/60 second, the display side scanner 24 supplies the displaying selection signal to the pixels 11 in order from above the display section 1 to change the display of the display cells CW of the all of the pixels 11 within a period of 1/240 second.

In FIGS. 11 to 13, a rightwardly downwardly slanting solid line indicates a timing at which the displaying selection signal is supplied to each of the pixels disposed along a row in the horizontal line direction of the display section 1. In the following description, those pixels which are arranged in a row in the horizontal line direction of the display section 1 are sometimes referred to merely as line.

It is to be noted that, also in FIGS. 15 to 17, 19 to 22, 25, 26, 28 and 32, a rightwardly downwardly slanting solid line indicates a timing at which the displaying selection signal is supplied in each line.

After a frame period starts, the light reception side scanner 32 supplies the receiving selection signal to the pixels 11 in order from above of the display section 1 so that the light reception cell CR of each of the pixels 11 outputs a reception light signal indicative of the detected light amount. In particular, at the starting point of time of the frame period, the light reception side scanner 32 supplies the light receiving selection signal to the light reception cells CR of the pixels 11 through the light receiving gate line GR1 and then supplies the light receiving selection signals to the light reception cells CR of the pixels 11 successively through the light receiving gate line GR2 to the light receiving gate line GRn.

The light reception cell CR of each of the pixels 11 to which the light receiving selection signal is supplied outputs a reception light signal representative of the received light amount, that is, the detected amount of light. Accordingly, when the light receiving selection signal is supplied to the light reception cells CR of the pixels 11 through the light receiving gate line GR1 to the light receiving gate line GRn, the display section 1 outputs reception light signals each representative of the light amount which is the sum total of the mount of reflected light reflected from an object which is in contact with or in the proximity of the display section 1 and external light received by the entire display section 1.

More particularly, after a frame period starts, the light reception side scanner 32 starts supply of the light receiving selection signal to the pixels 11. Then, the light reception side scanner 32 supplies the light receiving selection signal to all of the pixels 11 of the display section 1 within a period of ¼ the frame period so that the light reception cells CR of all of the pixels 11 of the display section 1 output reception light signals indicative the detected amounts of light. For example, where the frame period is 1/60 second, the light reception side scanner 32 supplies the light receiving selection signal to all of the pixels 11 of the display section 1 within a period of 1/240 second so that the light reception cells CR of all of the pixels 11 of the display section 1 output reception light signals indicative of the detected amounts of light.

When each of the light reception cells CR outputs the reception light signal, all of the charge retained in the light reception element PD of the light reception cell CR disappears. In particular, the light reception cells CR of pixels 11 of the display section 1 are reset by outputs of reception light signals from the light reception cells CR of all of the pixels 11 of the display section 1.

In the following description, a light receiving selection signal used to reset a light reception cell CR is referred to also as reset signal. In FIGS. 11 to 13, a broken line indicates a timing at which a reset signal is supplied in each line. It is to be noted that, also in FIGS. 15 to 17, 19 to 22, 25, 26, 28 and 32, a broken line indicates a timing at which a reset signal is supplied in each line.

Then, at a point of time at which a period ( 1/240 second) of ¼ the frame period elapses after the starting point of time of the frame period, the light reception side scanner 32 starts supply of the light receiving selection signal to the pixels 11 and supplies the light receiving selection signal to all of the pixel 11 of the display section 1 within a period of ¼ the frame period. The light reception side scanner 32 causes the light reception cells CR of all of the pixels 11 of the display section 1 to output reception light signals each indicative of the detected light amount before a point of time at which a period of ½ the frame period elapses.

Since the backlight source 2 continues to emit light within a period from the starting point of time of the frame period to the point of time at which the period of ½ the frame period elapses, within the period within which the backlight source 2 continues to emit light, the reception light signals each indicative of the amount of light detected by the light reception cell CR of each of the pixels 11 of the display section 1 are outputted.

In particular, since the light reception cells CR of all of the pixels 11 of the display section 1 are reset at the starting point of time of a frame period at which the backlight source 2 is turned on to emit light and then output the reception light signals within a period within which the backlight source 2 continues to emit light, each of the reception light signals indicates the total amount of light emitted from the backlight source 2 and reflected by an object which is in contact with or in the proximity of the display section 1 and external light.

In the following description, a light receiving selection signal for causing a reception light signal to be outputted in order to detect presence of an object which is in contact with or in the proximity of the display section 1 is referred to also as a reading out signal. In FIGS. 11 to 13, an alternate long and short dash line indicates a timing at which a reading out signal is supplied in each line. It is to be noted that, also in FIGS. 15 to 17, 19 to 22, 25, 26, 28 and 32, an alternate long and short dash line indicates a timing at which a reading out signal is supplied in each line.

At a point of time at which a period ( 1/120 second) of ½ the frame period elapses after the starting point of time of the frame period, the light reception side scanner 32 starts supply of the reset signal to the pixels 11 and supplies the reset signal to all of the pixel 11 of the display section 1 within a period of ¼ the frame period. Consequently, the light reception side scanner 32 causes the light reception cells CR of all of the pixels 11 of the display section 1 to output reception light signals each indicative of the detected light amount to reset the light reception cells CR of all of the pixel 11 of the display section 1.

Then, at a point of time at which a period ( 3/240 second) of ¾ the frame period elapses after the starting point of time of the frame period, the light reception side scanner 32 starts supply of the reading out signal to the pixels 11 and supplies the reading out signal to all of the pixels 11 of the display section 1 within a period of ¼ the frame period. The light reception side scanner 32 causes the light reception cells CR of all of the pixels 11 of the display section 1 to output reception light signals each indicative of the detected light amount before the ending time of the frame period.

Since the backlight source 2 continues to emit no light within a period from the point of time at which the period of ½ the frame period elapses to the ending point of time of the frame period, within the period within which the backlight source 2 continues to emit no light, the reception light signals each indicative of the amount of light detected by the light reception cell CR of each of the pixels 11 of the display section 1 are outputted.

In particular, since the light reception cells CR of all of the pixels 11 of the display section 1 are reset at the point of time at which a period of ½ the frame period within which the backlight source 2 remains off and emits no light and then output the reception light signals within a period within which the backlight source 2 continues to emit no light, each of the reception light signals indicates the amount of the external light.

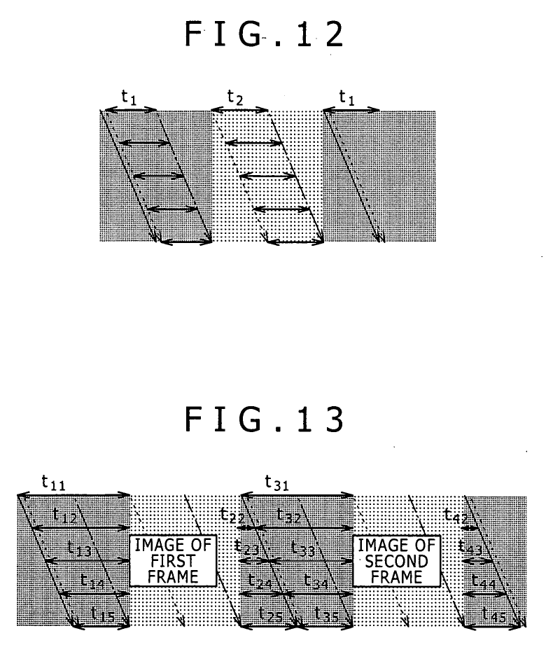

Since the reset signal and the reception light signal are outputted line sequentially as seen in FIG. 12, within a period within which the backlight source 2 emits light, the accumulation time (exposure time) which is a period of time within which charge generated by light reception of the light reception cells CR is accumulated is equal among those light reception cells CR which form one line (light reception cells CR disposed in one horizontal line) and equal among the lines.

In particular, the period t1 after a reset signal is received until a reading out signal is received within a period within which the backlight source 2 emits light is equal among the light reception cells CR of all of the pixels 11 of the display section 1. In other words, the period t1 after the light reception cells CR are reset until they output reading out signals to be used for detection of presence of an object which is in contact with or in the proximity of the display section 1 within a period within which the backlight source 2 emits light is equal among the light reception cells CR of all of the pixels 11 of the display section 1.

Further, since outputting of a reset signal and a reception light signal is performed line sequentially, the accumulation time which is a period of time within which charge generated by light reception of the light reception cells CR is accumulated within a period within which the backlight source 2 emits no light is equal among the light reception cells CR which form one line (light reception cells CR disposed along one horizontal line) and equal among the individual lines.

In particular, the period t2 after a reset signal is received until a reading out signal is received within a period within which the backlight source 2 emits no light is equal among the light reception cells CR of all of the pixels 11 of the display section 1. In other words, the period t2 after the light reception cells CR are reset until they output reception light signals to be used for detection of presence of an object which is in contact with or in the proximity of the display section 1 within a period within which the backlight source 2 emits no light is equal among the light reception cells CR of all of the pixels 11 of the display section 1.

FIG. 13 illustrates display times in a case wherein the period within which the backlight source 2 is to emit light and the period within which the backlight source 2 is to emit no light are each set to ½ the frame period and the display is updated at a starting point of time of a frame period.

When the backlight source 2 is off and does not emit light, since light from the backlight source 2 does not pass through the display cells CW of the pixels 11, the user cannot recognize an image displayed by the display section 1.

On the other hand, when the backlight source 2 is on and emits light, since light from the backlight source 2 passes through the display cells CW of the pixels 11 to form an image, the user can recognize the image displayed by the display section 1.

Those pixels 11 in the upper side line of the display section 1 whose display is updated first within a frame period pass light from the backlight source 2 therethrough so that an image of a first frame may be displayed within a period t11 after the starting time of the frame until the backlight source 2 is turned off.

Where the display of the entire display section 1 is to be updated within a period of 1/240 second, those pixels 11 of the line which is disposed at the position of ¼ of the display section 1 from the upper side whose display is updated when a period of 1/960 second (¼ of 1/240 second) elapses after the start of the frame pass light from the backlight source 2 therethrough so that an image of the first frame may be displayed within a period tl2 between the time at which the period of 1/960 second elapses after the start of the frame and the time at which the backlight source 2 is turned off and a period t22 between the point of time at which the backlight source 2 is turned on next and the point of time at which the display is updated in order to display an image of a next frame.

Where the display of the entire display section 1 is to be updated within a period of 1/240 second, those pixels 11 of the line disposed at the position of ½ of the display section 1 from the upper side whose display is updated when a period of 1/480 second (½ of 1/240 second) elapses after the start of the frame pass light from the backlight source 2 therethrough so that an image of the first frame may be displayed within a period t13 between the time at which the period of 1/480 second elapses after the start of the frame and the time at which the backlight source 2 is turned off and a period t23 between the point of time at which the backlight source 2 is turned on next and the point of time at which the display is updated in order to display an image of a next frame.

Where the display of the entire display section 1 is to be updated within a period of 1/240 second, those pixels 11 of the line disposed at the position of ¾ of the display section 1 from the upper side whose display is updated when a period of 1/320 second (¾ of 1/240 second) elapses after the start of the frame pass light from the backlight source 2 therethrough so that an image of the first frame may be displayed within a period t14 between the time at which the period of 1/320 second elapses after the start of the frame and the time at which the backlight source 2 is turned off and a period t24 between the point of time at which the backlight source 2 is turned on next and the point of time at which the display is updated in order to display an image of a next frame.

Where the display of the entire display section 1 is to be updated within a period of 1/240 second, those pixels 11 of the line disposed on the lower side of the display section 1 whose display is updated at the end pass light from the backlight source 2 therethrough so that an image of the first frame may be displayed within a period t15 between the time at which the period of 1/240 second elapses after the start of the frame and the time at which the backlight source 2 is turned off and a period t25 between the point of time at which the backlight source 2 is turned on next and the point of time at which the display is updated in order to display an image of a next frame.

A period of the sum of the period t12 and the period t22, another period of the sum of the period t13 and the period t23, a further period of the sum of the period t14 and the period t24 and a still further period of the sum of the period t15 and the period t25 are all equal to the period t11.

Accordingly, an image of the first frame is displayed for an equal period of time irrespective of the position on the display section 1.

Similarly, those pixels 11 on the upper side line of the display section 1 whose display is updated first within a frame period pass light from the backlight source 2 therethrough so that an image of a second frame may be displayed within a period t31 after the starting time of the frame until the backlight source 2 is turned off.

Where the display of the entire display section 1 is to be updated within a period of 1/240 second, those pixels 11 of the line which is disposed at the position of ¼ of the display section 1 from the upper side whose display is updated when a period of 1/960 second elapses after the start of the frame pass light from the backlight source 2 therethrough so that an image of the second frame may be displayed within a period t32 between the time at which the period of 1/960 second elapses after the start of the frame and the time at which the backlight source 2 is turned off and a period t42 between the point of time at which the backlight source 2 is turned on next and the point of time at which the display is updated in order to display an image of a next frame.

Where the display of the entire display section 1 is to be updated within a period of 1/240 second, those pixels 11 of the line disposed at the position of ½ of the display section 1 from the upper side whose display is updated when a period of 1/480 second (½ of 1/240 second) elapses after the start of the frame pass light from the backlight source 2 therethrough so that an image of the second frame may be displayed within a period t33 between the time at which the period of 1/480 second elapses after the start of the frame and the time at which the backlight source 2 is turned off and a period t43 between the point of time at which the backlight source 2 is turned on next and the point of time at which the display is updated in order to display an image of a next frame.

Where the display of the entire display section 1 is to be updated within a period of 1/240 second, those pixels 11 of the line disposed at the position of ¾ of the display section 1 from the upper side whose display is updated when a period of 1/320 second elapses after the start of the frame pass light from the backlight source 2 therethrough so that an image of the second frame may be displayed within a period t34 between the time at which the period of 1/320 second elapses after the start of the frame and the time at which the backlight source 2 is turned off and a period t44 between the point of time at which the backlight source 2 is turned on next and the point of time at which the display is updated in order to display an image of a next frame.

Where the display of the entire display section 1 is to be updated within a period of 1/240 second, those pixels 11 of the line disposed on the lower side of the display section 1 whose display is updated at the end pass light from the backlight source 2 therethrough so that an image of the second frame may be displayed within a period t35 between the time at which the period of 1/240 second elapses after the start of the frame and the time at which the backlight source 2 is turned off and a period t45 between the point of time at which the backlight source 2 is turned on next and the point of time at which the display is updated in order to display an image of a next frame.

A period of the sum of the period t32 and the period t42, another period of the sum of the period t33 and the period t43, a further period of the sum of the period t34 and the period t44 and a still further period of the sum of the period t35 and the period t45 are all equal to the period t31.

Accordingly, an image of the second frame is displayed for an equal period of time irrespective of the position on the display section 1.

In this manner, images of different frames are disposed for an equal period of time irrespective of the position on the display section 1.

It is to be noted that the backlight source 2 may be controlled otherwise such that, for every frame period, the backlight source 2 is kept off and emits no light after the starting time of the frame period till the point of time at which a period of ½ the frame period elapses and is kept on and emits light after the point of time at which the period of ½ the frame period elapses to the ending time of the frame period. Where the backlight source 2 is controlled in this manner, an after-image of an image displayed on the display section 1 can be reduced further.

Now, a scanning control process by the display signal retention control section 22 and the light reception control section 31 is described with reference to a flow chart of FIG. 14. First at step S11, the display signal retention control section 22 decides based on a display signal supplied thereto from the display signal production section 21 whether or not a starting point of time of a frame comes. If it is decided that a starting point of time of a frame does not come, then the display signal retention control section 22 repeats the decision process at step S11 until after a starting point of time of a frame comes.

If it is decided at step S11 that a starting point of time of a frame comes, then the processing advances to step S12, at which the display control section 51 of the display signal retention control section 22 controls the display side scanner 24 to start scanning of the displaying selection signal to the display section 1.

At step S13, the lighting control section 52 of the display signal retention control section 22 controls the backlight source 2 to emit light.

At step S14, the light reception control section 31 controls the light reception side scanner 32 based on the vertical synchronizing signal 43 supplied thereto from the display signal retention control section 22 to start scanning of the reset signal, which is a light receiving selection signal for resetting the light reception cells CR, to the display section 1.

At step S15, the light reception control section 31 decides whether or not predetermined time comes at which the time period from the present time to ½ the frame period is longer than the time period required for scanning of a light receiving selection signal. For example, in a case wherein the frame period is 1/60 second and the time required for scanning of a light receiving selection signal is 1/240 second, since ½ the frame period is 1/120 second, the light reception control section 31 decides at step S15 whether or not the period of time from the present time to ½ the frame period is 1/240 second, that is, whether or not the point of time at which 1/240 second elapses after the starting time of the frame comes. In this instance, the period t1 after the reset signal is received until the reading out signal is received within the period within which the backlight source 2 remains on and emits light is 1/240 second.

For example, in a case wherein the frame period is 1/60 second and the time required for scanning of a light receiving selection signal is 1/240 second, where the period t1 after the reset signal is received until the reading out signal is received within a period within which the backlight source 2 emits light is 1/480 second, the light reception control section 31 decides at step S15 whether or not the period of time from the present time to ½ the frame period is 1/160 second ( 1/240+ 1/480), that is, whether or not the point of time at which 1/480 second elapses after the starting time of the frame comes.

If it is decided at step S15 that the predetermined time does not come at which the time period from the present time to ½ the frame period is longer than the time period required for scanning of a light receiving selection signal, then the decision process at step S15 is repeated until after the predetermined time comes at which the time period from the present time to ½ the frame period is longer than the time period required for scanning of a light receiving selection signal.

If it is decided at step S15 that the predetermined time comes at which the time period from the present time to ½ the frame period is longer than the time period required for scanning of a light receiving selection signal, then the processing advances to step S16. At step S16, the light reception control section 31 controls the light reception side scanner 32 to start scanning of the reading out signal which is a light receiving selection signal for outputting a reception light signal to be used for detection of presence of an object which is in contact with or in the proximity of the display section 1 to the display section 1.

Since scanning of the reading out signal is started when the predetermined time comes at which the time period from the present time to ½ the frame period is longer than the time period required for scanning of a light receiving selection signal in this manner, scanning of the reading out signal from the entire display section 1 is completed within a period within which the backlight source 2 emits light.

At step S17, the lighting control section 52 decides whether or not ½ the frame period elapses. If it is decided that ½ the frame period does not elapse, then the decision process at step S17 is repeated until after ½ the frame period elapses. For example, where the frame period is 1/60, the lighting control section 52 decides at step S17 whether or not 1/120 second elapses after the starting time of the frame.

If it is decided at step S17 that ½ the frame period elapses, then the processing advances to step S18, at which the lighting control section 52 controls the backlight source 2 to stop the emission of light.

Then at step S19, the light reception control section 31 controls the light reception side scanner 32 to start scanning of the reset signal which is a light receiving selection signal to be used for resetting of the light reception cells CR to the display section 1 in response to a signal supplied thereto from the display signal retention control section 22 and representative of whether or not the backlight source 2 is turned on to emit light.

At step S20, the light reception control section 31 decides whether or not predetermined time comes at which the time period from the present time to the ending time of the frame is longer than the time period required for scanning of a light receiving selection signal. For example, in a case wherein the frame period is 1/60 second and the time required for scanning of a light receiving selection signal is 1/240 second, the light reception control section 31 decides at step S20 whether or not the period of time from the present time to the ending time of the frame is 1/240 second, that is, whether or not the point of time at which 1/80 second elapses after the starting time of the frame comes. In this instance, the period t2 after the reset signal is received until the reading out signal is received within a period within which the backlight source 2 emits no light is 1/240.

For example, in a case wherein the frame period is 1/60 second and the time required for scanning of a light receiving selection signal is 1/240 second, where the period t2 after the reset signal is received until the reading out signal is received within a period within which the backlight source 2 emits no light is 1/480 second, the light reception control section 31 decides at step S20 whether or not the period of time from the present time to the ending time of the frame is 1/160 second ( 1/240+ 1/480), that is, whether or not the point of time at which 5/480 seconds ( 1/120+ 1/480) elapse after the starting time of the frame comes.

If it decided at step S20 that the predetermined time does not yet come at which the time period from the present time to the ending time of the frame is longer than the time period required for scanning of a light receiving selection signal, then the decision process at step S20 is repeated until the predetermined time comes at which the time period from the present time to the ending time of the frame is longer than the time period required for scanning of a light receiving selection signal.

If it is decided at step S20 that the predetermined time comes at which the time period from the present time to the ending time of the frame is longer than the time period required for scanning of a light receiving selection signal, then the processing advances to step S21. At step S21, the light reception control section 31 controls the light reception side scanner 32 to start scanning of the reading out signal which is a light receiving selection signal to output a reception light signal to be used for detection of presence of an object which is in contact with or in the proximity of the display section 1. Thereafter, the processing returns to step S11 so that the processes described above are repeated.

Since scanning of the reading out signal is started when the predetermined time comes at which the time period from the present time to the ending time of the frame is longer than the time period required for scanning of a light receiving selection signal in this manner, scanning of the reading out signal from the entire display section 1 is completed within a period within which the backlight source 2 emits no light.

As described above, from a reception light signal obtained by subtracting a reception light signal representative of the amount of light received within a period within which the backlight source 2 is off and does not emit light from another reception light signal representative of the amount of light received within another period within which the backlight source 2 is on and emits light, presence of an object which is in contact with or in the proximity of the display section 1 or the position of an object which is in contact with or in the proximity of the display section 1 can be detected with a higher degree of accuracy without being influenced by the intensity of external light.

FIG. 15 illustrates the reset signal and the reception light signal where the accumulation time which is a period of time within which charge generated by reception of light by the light reception cells CR is accumulated is set longer.

It is necessary for outputting of the reset and light reception signals to be completed with regard to the light reception cells CR of all of the pixels 11 of the display section 1 within one of a period within which the backlight source 2 emits light and another period within which the backlight source 2 emits no light.

Accordingly, when the accumulation time which is a period of time within which charge generated by light reception by the light reception cells CR is accumulated is elongated, it is necessary to reduce the time required for scanning of a light receiving selection signal. For example, where the frame period is 1/60 second, if the time period (t1 or t2 in FIG. 15) for accumulating charge generated by light reception by the light reception cells CR is 3/480 seconds, then the time required for scanning of a light receiving selection signal must be 1/480 second.

On the contrary, if the time required for scanning of a light receiving selection signal can be reduced, then it is possible to increase the accumulation time which is a period of time within which charge generated by light reception by the light reception cells CR is accumulated. For example, if the time required for accumulating charge of a light receiving selection signal can be reduced, then it is possible to use a light receiving cell of a comparatively low sensitivity for the light reception cells CR. Where light receiving cells of an equal sensitivity are used, if the accumulation time is increased, then the S/N ratio of the reception light signal can be raised (noise can be reduced).

FIG. 16 illustrates outputting of the resetting signal and the reception light signal to the light reception cells CR where the time required for scanning of a light receiving selection signal is set longer.

As described hereinabove, it is necessary for outputting of the reset and light reception signals to be completed with regard to the light reception cells CR of all of the pixels 11 of the display section 1 within one of a period within which the backlight source 2 emits light and another period within which the backlight source 2 emits no light.

Accordingly, if the time required for scanning of a light receiving selection signal is elongated, then it is necessary to decrease the accumulation time which is a period of time within which charge generated by light reception by the light reception cells CR is accumulated. For example, where the frame period is 1/60 second, if the time period required for scanning of a light receiving selection signal is 3/480 seconds, then it is necessary to set the time period (t1 or t2 in FIG. 16) for accumulating charge generated by light reception by the light reception cells CR to 1/480.

On the contrary, if the accumulation time which is a period of time within which charge generated by light reception by the light reception cells CR is accumulated can be reduced, then it is possible to increase the time required for scanning of a light receiving selection signal. For example, if a light receiving cell of a comparatively high sensitivity can be used for the light reception cells CR, then it is possible to increase the time required for scanning of a light receiving selection signal.

While the foregoing description relates to a case wherein the period within which the backlight source 2 emits light and the period within which the backlight source 2 emits no light are set equal to each other, the period within which the backlight source 2 emits light may be set shorter than the period within which the backlight source 2 emits no light.

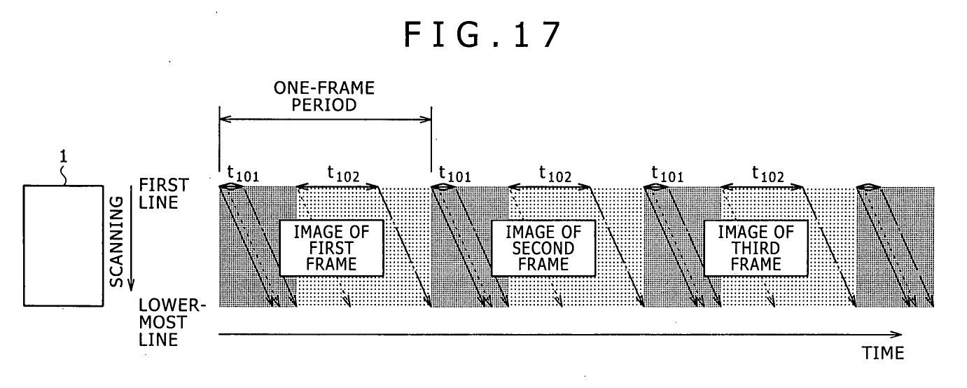

FIG. 17 illustrates scanning of the displaying selection signal where the period within which the backlight source 2 emits light is set to 33% of the frame period. The vertical direction of FIG. 17 indicates a vertical line direction along which the displaying selection signal is scanned on the display section 1. The horizontal direction of FIG. 17 indicates the time.

The lighting control section 52 of the display signal retention control section 22 controls, for each frame period, the backlight source 2 to emit light from a starting point of time of the frame period to a point of time at which a period of 33% of the frame period elapses and to stop the light emission from the point of time at which the period of 33% of the frame period elapses to an ending point of time of the frame period.

It is to be noted that, in order to make the luminance of the display section 1 fixed, it is necessary to set the luminance of the backlight source 2 where the period within which the backlight source 2 is on and emits light to 1/0.33 time, that is, to approximately 3 times the luminance of the backlight source 2 where the backlight source 2 continues to emit light.

Even if the accumulation time (exposure time) which is a period of time within which charge generated by light reception by the light reception cells CR is accumulated is reduced, the amount of light reflected from an object which is in the proximity of the display section 1 can be increased by raising the luminance of the backlight source 2. Therefore, a reception light signal of a higher level can be acquired within a period of time within which the backlight source 2 emits light.

Since the period within which the backlight source 2 emits no light increases, the accumulation time (exposure time) of the light reception cells CR within a period within which the backlight source 2 emits no light can be increased.

After a frame period starts, the display side scanner 24 changes the display of the display cells CW of all of the pixels 11 of the display section 1 within a period of ¼ of the frame period.

After the frame period starts, the light reception side scanner 32 starts supply of the reset signal to the pixels 11 and supplies the reset signal to all of the pixels 11 of the display section 1 within a period of ¼ of the frame period (within a period of 25% of the frame period) to reset the light reception cells CR of all of the pixels 11 of the display section 1.

At a point of time at which a period of 7% (33%-25%) of the frame period from the starting time of the frame period elapses, the light reception side scanner 32 starts supply of the reading out signal to the pixels 11 and supplies the reading out signal to all of the pixels 11 of the display section 1 within a period of 33% of the frame period.

In this instance, the period t101 after the reset signal is received until the reading out signal is received within a period within which the backlight source 2 emits light (that is, an accumulation time period which is a period of time within which charge generated by light reception of the light reception cells CR is accumulated within a period within which the backlight source 2 emits light) is a period of time equal to 7% of the length of the frame period.

At a point of time at which the period of 33% of the frame period elapses after the starting time of the frame period, the light reception side scanner 32 starts supply of the reset signal to the pixels 11 and supplies the reset signal to all of the pixels 11 of the display section 1 within a period of ¼ of the frame period to reset the light reception cells CR of all of the pixels 11 of the display section 1.

At a point of time at which a period of 75% (100%-25%) of the frame period from the starting time of the frame period elapses, the light reception side scanner 32 starts supply of the reading out signal to the pixels 11 and supplies the reading out signal to all of the pixels 11 of the display section 1 before the ending time of the frame period.

In this instance, the period t102 after the reading out signal is received until the reset signal is received within a period within which the backlight source 2 emits no light (that is, an accumulation time period which is a period of time within which charge generated by light reception of the light reception cells CR is accumulated within a period within which the backlight source 2 emits no light) is a period of time equal to 42% (75%-33%) of the length of the frame period.

From a light reception signal obtained by subtracting a value obtained by multiplying a reception light signal representative of the amount of light received within a period within which the backlight source 2 does not emit light by a weight corresponding to the length of the accumulation time period from a value obtained by multiplying a light reception signal representative of the amount of light received within a period within which the backlight source 2 is on and emits light by a weight corresponding to the length of the storage time, presence of an object which is in contact with or in the proximity of the display section 1 or the position of an object which is in contact with or in the proximity of the display section 1 can be detected with a higher degree of accuracy without being influenced by the intensity of external light. For example, where the period within which the backlight source 2 emits light is set to 33% of the frame period, presence of an object which is in contact with or in the proximity of the display section 1 or the position of an object which is in contact with or in the proximity of the display section 1 can be detected from a light reception signal obtained by subtracting a value obtained by multiplying a reception light signal representative of the amount of light received within a period within which the backlight source 2 does not emit light by 1/42 (1%/42%) from a value obtained by multiplying a light reception signal representative of an amount of light received within a period within which the backlight source 2 is on and emits light by 1/7 (1%/7%).

It is to be noted that the period within which the backlight source 2 emits light is not limited to 33% of the frame period but can be set to a period of an arbitrary length.

Where the time required for scanning of the reset signal and the reading out signal is represented by s (seconds), the period b (seconds) within which the backlight source 2 emits light must exceed s (seconds). The period t101 after the reset signal is received until the reading out signal is received within a period within which the backlight source 2 emits light is b−s at the longest. Further, where the frame period is f (seconds), the period t102 after the reset signal is received until the reading out signal within a period within which the backlight source 2 emits no light is f−s−b at the longest.

If the period t101 is b−s and the period t102 is f−s−b, then where the reception light signal representative of the amount of light received within a period within which the backlight source 2 emits light is represented by Da and the reception light signal representative of the amount of light received within a period within which the backlight source 2 emits no light is represented by Db, the value of a signal for detecting presence of an object which is in contact with or in the proximity of the display section 1 or the position of an object which is in contact with or in the proximity of the display section 1 can be calculated by Da/(b−s)−Db/(f−s−b).

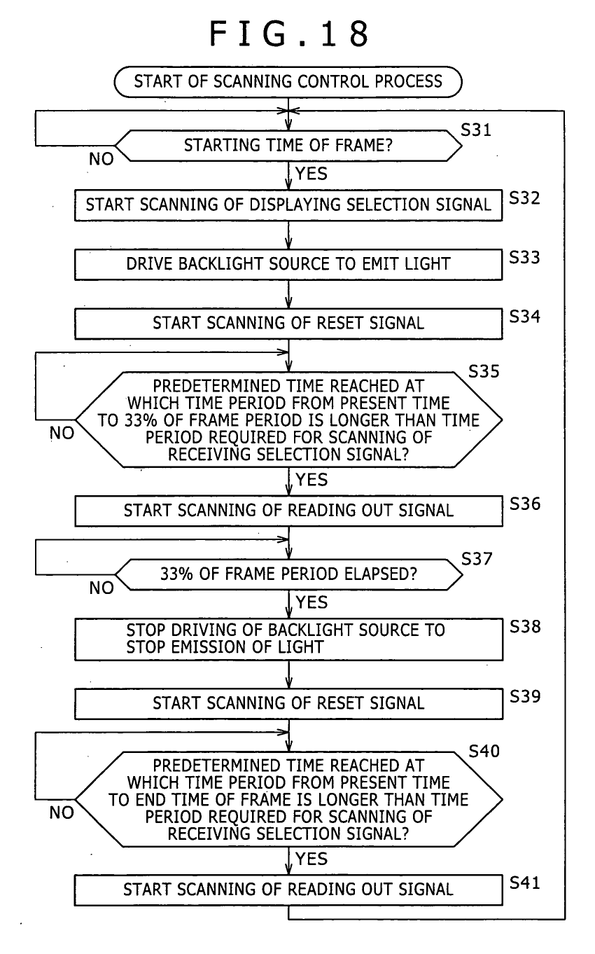

Now, another scanning control process is described with reference to a flow chart of FIG. 18. Processes at steps S31 to S34 of FIG. 18 are similar to those at steps S11 to S14 of FIG. 14, respectively, and therefore, overlapping description of them is omitted herein to avoid redundancy.

At step S35, the light reception control section 31 decides whether or not predetermined time comes at which the time period from the present time to 33% of the frame period is longer than the time period required for scanning of the receiving selection signal. If it is decided at step S35 that the predetermined time does not come at which the time period from the present time to 33% of the frame period is longer than the time period required for scanning of the receiving selection signal, then the decision process at step S35 is repeated until the predetermined time comes at which the time period from the present time to 33% of the frame period is longer than the time period required for scanning of the receiving selection signal.

Then, if it is decided at step S35 that the predetermined time comes at which the time period from the present time to 33% of the frame period is longer than the time period required for scanning of the receiving selection signal, then the processing advances to step S36. At step S36, the light reception control section 31 controls the light reception side scanner 32 to start scanning of the reading out signal which is a light receiving selection signal for outputting a reception light signal used for detection of presence of an object which is in contact with or in the proximity of the display section 1 to the display section 1.

In this manner, when the predetermined time comes at which the time period from the present time to 33% of the frame period is longer than the time period required for scanning of the receiving selection signal, scanning of the reading out signal is started. Consequently, within a period within which the backlight source 2 emits light, scanning of the reading out signal from the entire display section 1 is completed.

At step S37, the lighting control section 52 decides whether or not 33% of the frame period elapses. If it is decided that 33% of the frame period does not elapse, then the decision process is repeated until after 33% of the frame period elapses.

If it is decided at step S37 that 33% of the frame period elapses, then the processing advances to step S38, at which the lighting control section 52 turns off the backlight source 2 to stop emission of light.

Processes at steps S39 to S41 are similar to those at steps S19 to S21 of FIG. 14, respectively, and therefore, overlapping description of them is omitted herein to avoid redundancy.

Based on a reception light signal detected by the process described above with reference to the flow chart of FIG. 18, presence of an object which is in contact with or in the proximity of the display section 1 or the position of an object which is in contact with or in the proximity of the display section 1 can be detected with a higher degree of accuracy. In particular, from a light reception signal obtained by subtracting a value obtained by multiplying a reception light signal representative of the amount of light received within a period within which the backlight source 2 does not emit light by a weight corresponding to the length of the accumulation time period from a value obtained by multiplying a light reception signal representative of an amount of light received within a period within which the backlight source 2 is on and emits light by a weight corresponding to the length of the storage time, presence of an object which is in contact with or in the proximity of the display section 1 or the position of an object which is in contact with or in the proximity of the display section 1 can be detected with a higher degree of accuracy without being influenced by the intensity of external light.

It is to be noted that the period within which the backlight source 2 emits light may be set longer than the period within which the backlight source 2 emits no light.

Now, a case wherein the backlight source 2 is controlled to blink in a period same as the period of a frame while the timing of blinking of the backlight source 2 is set independently of the starting time of a frame is described.

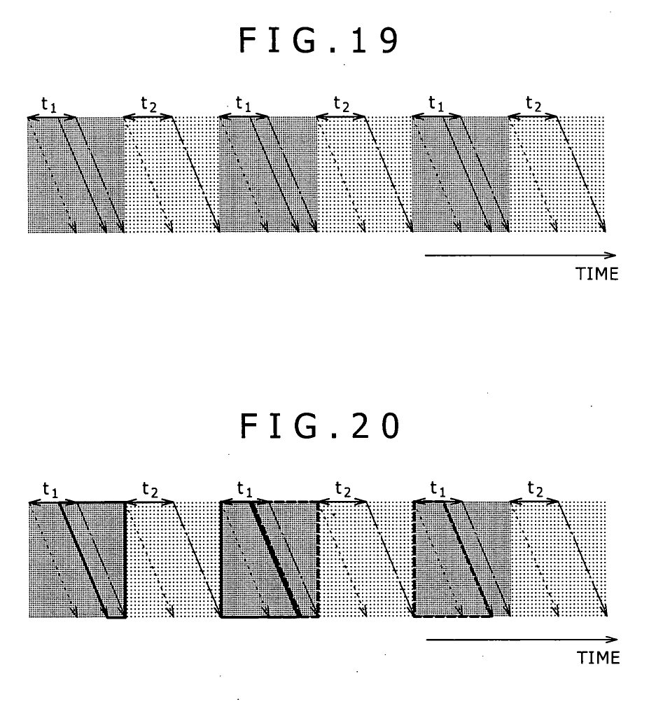

FIGS. 19 to 22 illustrate blinking of the backlight source 2 and scanning of a light receiving selection signal and the displaying selection signal. The vertical direction of FIGS. 19 to 22 indicates a vertical line direction along which the displaying selection signal is scanned on the display section 1. The horizontal direction of FIGS. 19 to 22 indicates the time.

In FIGS. 19 to 22, the relationship between a timing of blinking of the backlight source 2 and timings at which the reset signal and the reading out signal are supplied is similar to that in the case illustrated in FIG. 11.

FIG. 19 illustrates an example wherein the displaying selection signal is scanned between scanning of the reset signal and scanning of the reading out signal. In the example illustrated in FIG. 19, within a period after scanning of the reset signal is started until scanning of the reading out signal is started within a period within which the backlight source 2 emits light, the display control section 51 controls the display side scanner 24 to start scanning of the displaying selection signal.

FIG. 20 illustrates display times where scanning of the displaying selection signal is started between starting of scanning of the reset signal and starting of scanning of the reading out signal.

Referring to FIG. 20, a region surrounded by a thick solid line indicates a period within which an image of a first frame is displayed, and a region surrounded by a thick broken line indicates a period within which an image of a second frame is displayed. The length of the period within which the image of the first frame is displayed is fixed and the length of the period within which the image of the second frame is displayed is fixed irrespective of the position on the display section 1. Further, the length of the period within which the image of the first frame is displayed is equal to the length of the period within which the image of the second frame is displayed.

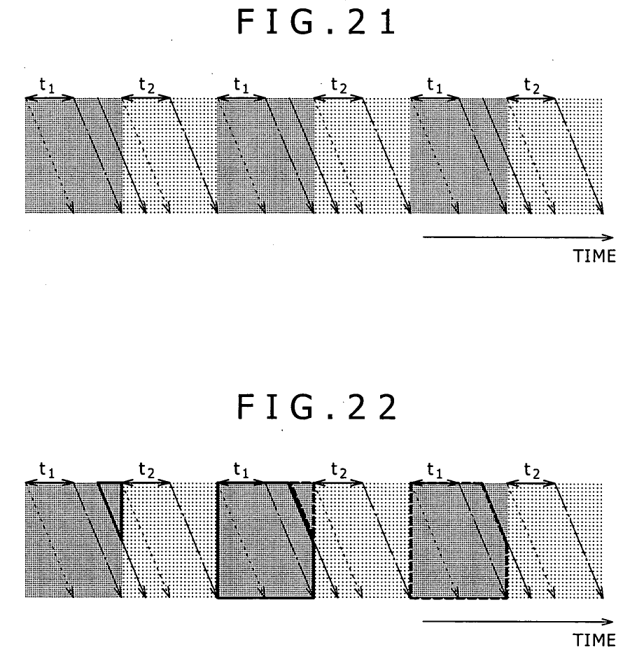

FIG. 21 illustrates an example wherein scanning of the displaying selection signal is started between starting of scanning of the reading out signal and starting of scanning of the reset signal. In the example illustrated in FIG. 21, the display control section 51 controls the display side scanner 24 to start scanning of the displaying selection signal within a period after scanning of the reading out signal is started until scanning of the reset signal is started. In this instance, intermediately during scanning of the displaying selection signal, the backlight source 2 stops emission of light.

FIG. 22 illustrates display times where scanning of the displaying selection signal is started between starting of scanning of the reading out signal and starting of scanning of the reset signal.

Referring to FIG. 22, a region surrounded by a thick solid line indicates a period within which an image of a first frame is displayed, and a region surrounded by a thick broken line indicates a period within which an image of a second frame is displayed. The length of the period within which the image of the first frame is displayed is fixed and the length of the period within which the image of the second frame is displayed is fixed irrespective of the position on the display section 1. Further, the length of the period within which the image of the first frame is displayed is equal to the length of the period within which the image of the second frame is displayed.

If the backlight source 2 is controlled so as to blink in a period same as the period of a frame in this manner, then even if the timing of the blinking of the backlight source 2 is set independently of the starting time of the frame, the entire image of a frame is displayed within an equal display period of time.

Where the displaying selection signal is scanned within a period within which the backlight source 2 does not emit light, an after-image of an image displayed by the display section 1 can be reduced.

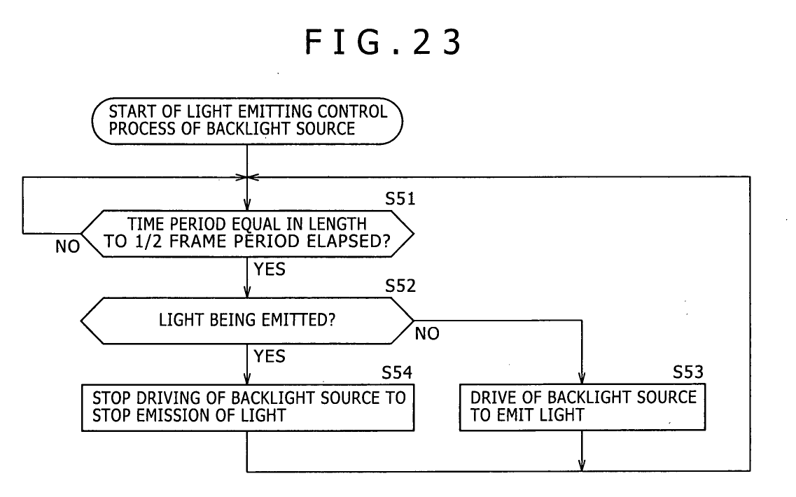

FIG. 23 illustrates a light emission control process of the backlight source 2 where the blinking timing of the backlight source 2 is independent of the starting time of a frame. Referring to FIG. 23, at step S51, the lighting control section 52 of the display signal retention control section 22 decides whether or not a period of time having a length equal to ½ of the period of a frame elapses. If it is decided that a period of time having a length equal to ½ of the period of a frame elapses, then the decision process at step S51 is repeated until a period of time having a length equal to ½ of the period of a frame elapses.

If it is decided at step S51 that a period of time having a length equal to ½ of the period of a frame elapses, then the processing advances to step S52. At step S52, the lighting control section 52 decides based on a state of the lighting control section 52 itself whether or not the backlight source 2 emits light. If it is decided that the backlight source 2 does not emit light, then the processing advances to step S53, at which the lighting control section 52 controls the backlight source 2, which is in an off state, to emit light. Thereafter, the processing returns to step S51 to repeat the processes described above.

If it is decided at step S52 that the backlight source 2 emits light, then the processing advances to step S54, at which the lighting control section 52 turns off the backlight source 2 which is in a light emitting state. Thereafter, the processing returns to step S51 to repeat the processes described above.

In this manner, the backlight source 2 can be controlled to blink in a period equal to the period of a frame independently of the starting time of the frame, and an entire image of a frame is displayed within an equal display time period.

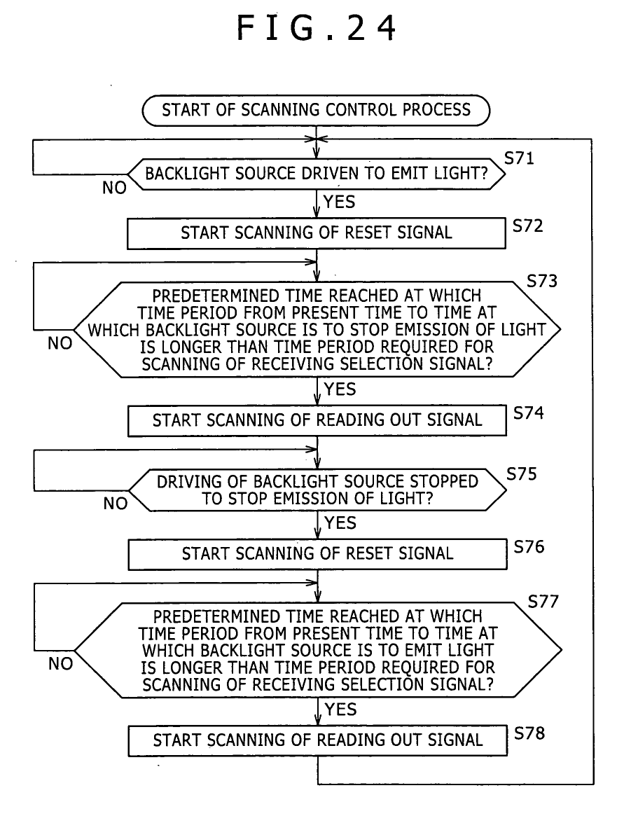

Now, a scanning processing control where the backlight source 2 is controlled to blink in a period equal to the period of a frame independently of the starting time of a frame is described with reference to a flow chart of FIG. 24.

Referring to FIG. 24, at step S71, the light reception control section 31 decides based on the signal from the display signal retention control section 22 whether or not the backlight source 2 is on and emits light. If the backlight source 2 is not on, then the decision process at step S71 is repeated until after the backlight source 2 is turned on to emit light.

If it is decided at step S71 that the backlight source 2 is on and emits light, then the processing advances to step S72. At step S72, the light reception control section 31 controls the light reception side scanner 32 to start scanning of the reset signal which is a light receiving selection signal to be used to reset the light reception cells CR to the display section 1.

At step S73, the light reception control section 31 decides whether or not predetermined time comes at which the period of time from the present time to the time at which the backlight source 2 is turned off to stop the emission of light is longer than the time period required for scanning of the receiving selection signal. If it is decided that the predetermined time does not come at which the period of time from the present time to the time at which the backlight source 2 is turned off to stop the emission of light is longer than the time period required for scanning of the receiving selection signal, then the decision process at step S73 is repeated.

For example, in a case wherein the frame period is 1/60 second and the time required for scanning of a light receiving selection signal is 1/240 second, since the period within which the backlight source 2 emits light is 1/120 second, the light reception control section 31 decides at step S73 whether or not the period of time to the time at which the backlight source 2 is to be turned off to stop the emission of light is 1/240, that is, whether or not the point of time comes at which 1/240 second elapses after the backlight source 2 is turned on to emit light.

If it is decided at step S73 that the point of time comes at which the period of time from the present time to the time at which the backlight source 2 is turned off to stop emission of light is longer than the time period required for scanning of the receiving selection signal, then the processing advances to step S74. At step S74, the light reception control section 31 controls the light reception side scanner 32 to start scanning of the reading out signal which is a light receiving selection signal for outputting a reception light signal to be used for detection of presence of an object which is in contact with or in the proximity of the display section 1 to the display section 1.

In this manner, when the predetermined point of time comes at which the period of time from the present time to the time at which the backlight source 2 is turned off to stop emission of light is longer than the time period required for scanning of the receiving selection signal, scanning of the reading out signal is started. Consequently, scanning of the reading out signal from the entire display section 1 is completed within a period within which the backlight source 2 emits light.

At step S75, the light reception control section 31 decides based on the signal from the display signal retention control section 22 whether or not the backlight source 2 is turned off to stop emission of light. If it is decided that the backlight source 2 is not turned off, then the decision process at step S75 is repeated until the backlight source 2 is turned off.

If it is decided at step S75 that the backlight source 2 is turned off, then the processing advances to step S76, at which the light reception control section 31 controls the light reception side scanner 32 to start scanning of the reset signal which is a light receiving selection signal for outputting a reception light signal to be used to reset the light reception cells CR to the display section 1.

At step S77, the light reception control section 31 decides whether or not predetermined time comes at which the time period from the present time to the time at which the backlight source 2 is turned on to emit light is longer than the time period required for scanning of the receiving selection signal.

For example, in a case wherein the frame period is 1/60 second and the time required for scanning of a light receiving selection signal is 1/240 second, since the period within which the backlight source 2 emits light is 1/120 second, the light reception control section 31 decides at step S77 whether or not the period of time to the time at which the backlight source 2 is to be turned on to emit light is 1/240, that is, whether or not the point of time comes at which 1/240 second elapses after the backlight source 2 is turned off to stop the emission of light.

If it is decided at step S77 that the predetermined time does not come at which the time period from the present time to the time at which the backlight source 2 is turned on to emit light is longer than the time period required for scanning of the receiving selection signal, then the decision process at step S77 is repeated until the predetermined time comes at which the time period from the present time to the time at which the backlight source 2 is turned on to emit light is longer than the time period required for scanning of the receiving selection signal.

If it is decided at step S77 that the predetermined time comes at which the time period from the present time to the time at which the backlight source 2 is turned on to emit light is longer than the time period required for scanning of the receiving selection signal, then the processing advances to step S78. At step S78, the light reception control section 31 controls the light reception side scanner 32 to start scanning of the reading out signal which is a light receiving selection signal for outputting a reception light signal to be used for detection of presence of an object which is in contact with or in the proximity of the display section 1. Thereafter, the processing returns to step S71 to repeat the processes described above.

Since scanning of the reading out signal is started when the predetermined time comes at which the time period from the present time to the time at which the backlight source 2 is turned on to emit light is longer than the time period required for scanning of the receiving selection signal in this manner, scanning of the reading out signal from the entire display section 1 is completed within a period within which the backlight source 2 remains off and emits no light.

From a light reception signal obtained by subtracting a reception light signal representative of the amount of light received within a period within which the backlight source 2 does not emit light from a light reception signal representative of the amount of light received within a period within which the backlight source 2 is on and emits light, presence of an object which is in contact with or in the proximity of the display section 1 or the position of an object which is in contact with or in the proximity of the display section 1 can be detected with a higher degree of accuracy without being influenced by the intensity of external light.

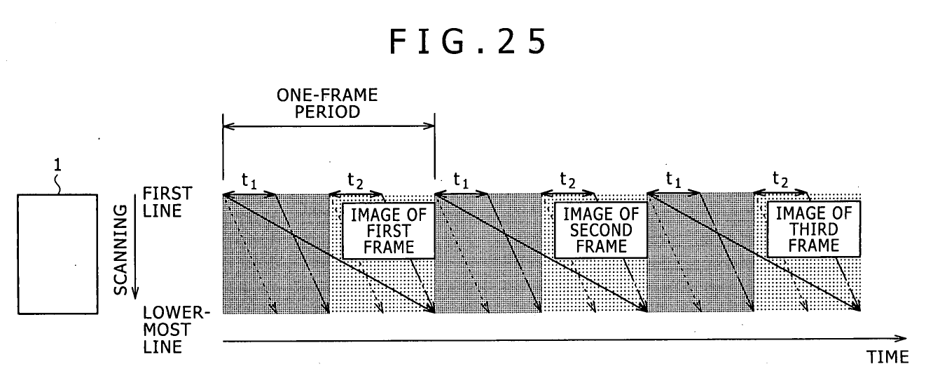

Now, a second embodiment of the present invention is described with reference to FIGS. 25 to 27. The second embodiment is a modification to and is different from the first embodiment in the period of time required for scanning of the displaying selection signal.

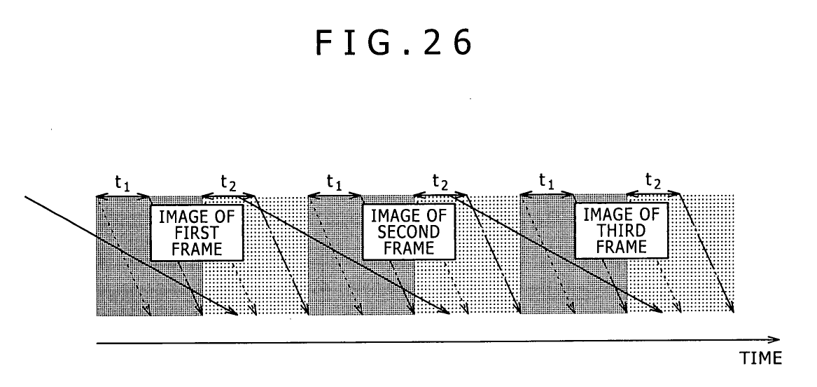

FIGS. 25 and 26 illustrate scanning of the displaying selection signal where the display of the display cells CW of all of the pixels 11 of the display section 1 is changed within a period equal in length to the frame period. The vertical direction of FIGS. 25 and 26 indicates a vertical line direction along which the displaying selection signal is scanned on the display section 1. The horizontal direction of FIGS. 25 and 26 indicates the time.

In the examples illustrated in FIGS. 25 and 26, the reset signal and the reading out signal are scanned within a period of ¼ of the frame period. In other words, the reset signal and the reading out signal are supplied to all of the pixels 11 of the display section 1 in the order of lines within a period of ¼ of the frame period.

In the examples illustrated in FIGS. 25 and 26, the backlight source 2 blinks in a period equal in length to the frame period. In this instance, the period within which the backlight source 2 emits light has a length of ½ of the frame period, and the period within which the backlight source 2 emits no light has a length of ½ of the frame period.

In the example illustrated in FIG. 25, the displaying selection signal is scanned within a period equal in length to the frame period. In the example illustrated in FIG. 25, scanning of the displaying selection signal is started when the backlight source 2 is turned on to emit light. In particular, the displaying selection signal is scanned within an entire frame period, and the period of the frame period and the period of blinking of the backlight source 2 are synchronized with each other.

For example, where the frame period is 1/60 second, the displaying selection signal is scanned within a period of 1/60 second, and the reset signal and the reading out signal are scanned within a period of 1/240 second.

As seen in FIG. 26, scanning of the displaying selection signal can be started independently of the blinking period of the backlight source 2 similarly as in the case described hereinabove with reference to FIGS. 19 to 22. In the example illustrated in FIG. 26, while the displaying selection signal is scanned within a period equal in length to the frame period, the timing of starting of scanning of the displaying selection signal can be set arbitrarily independently of the timing of blinking of the backlight source 2.

Where the displaying selection signal is scanned within a period equal in length to the frame period and the timing of starting of scanning of the displaying selection signal is set independently of the timing of blinking of the backlight source 2, the display control section 51, display signal driver 23 and display side scanner 24 can be formed from those of a display apparatus which merely displays an image.

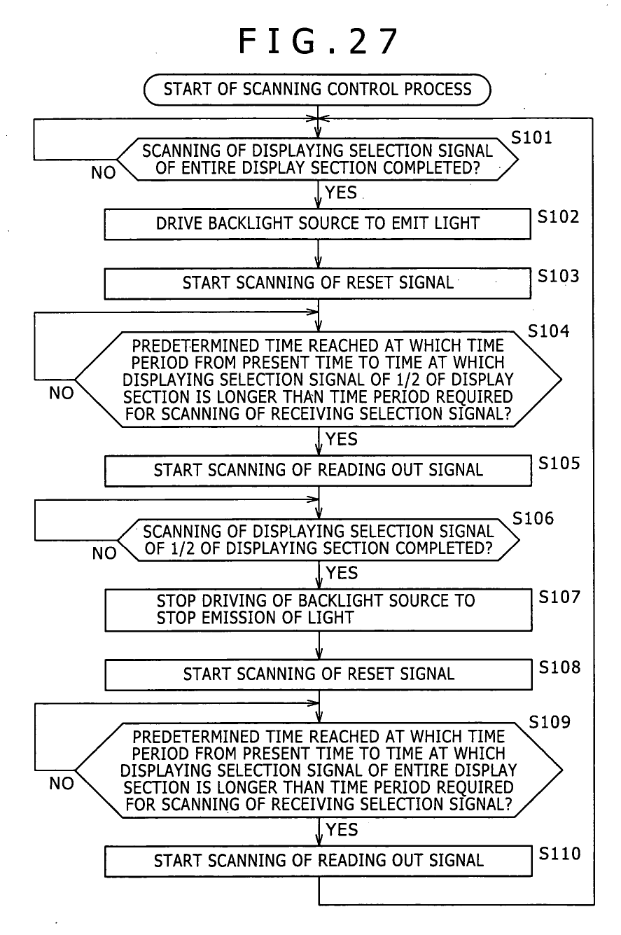

FIG. 27 illustrates a scanning control process where the displaying selection signal is scanned within a period equal in length to the frame period and the period of the frame period and the period of blinking of the backlight source 2 are synchronized with each other.

Referring to FIG. 27, at step S101, the display signal retention control section 22 decides whether or not scanning of the displaying selection signal of the entire display section 1 is completed. If it is decided that scanning of the displaying selection signal of the entire display section 1 is not completed, then the decision process at step S101 is repeated until scanning of the displaying selection signal of the entire display section 1 is completed.

If it is decided at step S101 that scanning of the displaying selection signal of the entire display section 1 is completed, then the processing advances to step S102, at which the lighting control section 52 of the display signal retention control section 22 controls the backlight source 2 to emit light.

At step S103, the light reception control section 31 controls, based on the signal supplied thereto from the display signal retention control section 22 and indicative of whether or not scanning of the displaying selection signal of the entire display section 1 is completed, the light reception side scanner 32 to start scanning of the reset signal which is a light receiving selection signal to be used to reset the light reception cells CR to the display section 1.

At step S104, the light reception control section 31 decides whether or not predetermined time comes at which the period of time from the present time to the time at which scanning of the displaying selection signal of ½ of the display section 1 is completed is longer than the time period required for scanning of a light receiving selection signal. If it is decided at step S104 that the predetermined time does not come at which the period of time from the present time to the time at which scanning of the displaying selection signal of ½ of the display section 1 is completed is longer than the time period required for scanning of a light receiving selection signal, then the decision process at step S104 is repeated until the predetermined time comes at which the period of time from the present time to the time at which scanning of the displaying selection signal of ½ of the display section 1 is completed is longer than the time period required for scanning of a light receiving selection signal.

If it is decided at step S104 that the predetermined time comes at which the period of time from the present time to the time at which scanning of the displaying selection signal of ½ of the display section 1 is completed is longer than the time period required for scanning of a light receiving selection signal, then the processing advances to step S105. At step S105, the light reception control section 31 controls the light reception side scanner 32 to start scanning of the reading out signal which is a light receiving selection signal for outputting a reception light signal to be used for detection of presence of an object which is in contact with or in the proximity of the display section 1.

At step S106, the display signal retention control section 22 decides whether or not scanning of the displaying selection signal of ½ of the display section 1 is completed. If it is decided that scanning of the displaying selection signal of ½ of the display section 1 is not completed, then the decision process at step S106 is repeated until scanning of the displaying selection signal of ½ of the display section 1 is completed.

If it is decided at step S106 that scanning of the displaying selection signal of ½ of the display section 1 is completed, then the processing advances to step S107, at which the lighting control section 52 controls the backlight source 2 to stop the emission of light.

At step S108, the light reception control section 31 controls the light reception side scanner 32 to start scanning of the reset signal which is a light receiving selection signal to be used to reset the light reception cells CR to the display section 1.

At step S109, the light reception control section 31 decides whether or not predetermined time comes at which the time period from the present time to the time at which scanning of the displaying selection signal of the entire display section 1 is completed is longer than the time period required for scanning of the receiving selection signal. If it is decided at step S109 that the predetermined time does not come at which the time period from the present time to the time at which scanning of the displaying selection signal of the entire display section 1 is completed is longer than the time period required for scanning of the receiving selection signal, then the decision process at step S109 is repeated until the predetermined time comes at which the time period from the present time to the time at which scanning of the displaying selection signal of the entire display section 1 is completed is longer than the time period required for scanning of the receiving selection signal.

If it is decided at step S109 that the predetermined time comes at which the time period from the present time to the time at which scanning of the displaying selection signal of the entire display section 1 is completed is longer than the time period required for scanning of the receiving selection signal, then the processing advances to step S110. At step S110, the light reception control section 31 controls the light reception side scanner 32 to start scanning of the reading out signal which is a light receiving selection signal for outputting a reception light signal to be used for detection of presence of an object which is in contact with or in the proximity of the display section 1. Thereafter, the processing returns to step S101 so that the processes described above are repeated.

In this manner, the backlight source 2 is turned on to emit light when scanning of the displaying selection signal of the entire display section 1 is completed, but is turned off to stop the emission of light when scanning of the displaying selection signal of ½ of the display section 1 is completed, and is turned on and off in synchronism with the scanning of the displaying selection signal.

Further, when a certain point of time comes at which the period of time from the present time to the time at which scanning of the displaying selection signal of ½ of the display section 1 is completed is longer than the time period required for scanning of a light receiving selection signal, scanning of the reading out signal is started. Consequently, scanning of the reading out signal from the entire display section 1 is completed within a period within which the backlight source 2 is on and emits light. Further, when a certain point of time comes at which the time period from the present time to the time at which scanning of the displaying selection signal of the entire display section 1 is completed is longer than the time period required for scanning of the receiving selection signal, scanning of the reading out signal is started. Consequently, scanning of the reading out signal from the entire display section 1 is completed within a period within which the backlight source 2 is off and emits no light.

As described above, from a light reception signal obtained by subtracting a reception light signal representative of the amount of light received within a period within which the backlight source 2 is off and does not emit light from a light reception signal representative of the amount of light received within a period within which the backlight source 2 is on and emits light, presence of an object which is in contact with or in the proximity of the display section 1 or the position of an object which is in contact with or in the proximity of the display section 1 can be detected with a higher degree of accuracy without being influenced by the intensity of external light.

A process where the displaying selection signal is scanned in a period equal in length to the frame period and scanning of the displaying selection signal is started independently of the blinking period of the backlight source 2 is similar to that described hereinabove with reference to FIGS. 23 and 24. Therefore, overlapping description of the process mentioned is omitted herein to avoid redundancy.

Now, a third embodiment wherein the blinking period of the backlight source 2 is set to twice the frame period is described.

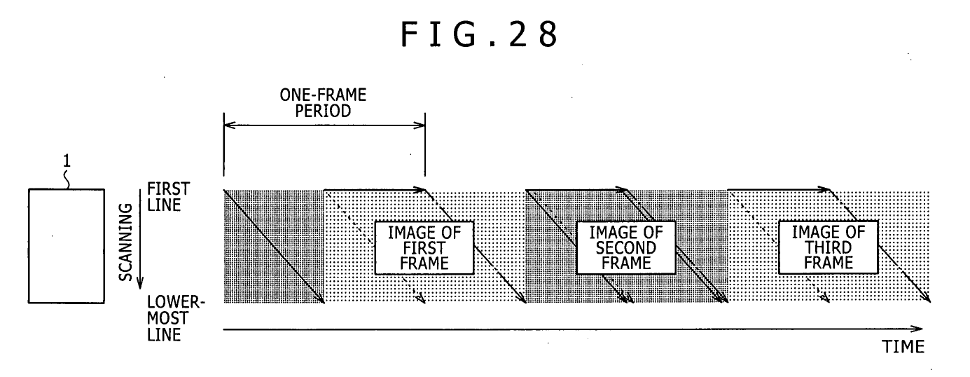

FIG. 28 illustrates scanning of the displaying selection signal and scanning of a light receiving selection signal where the blinking period of the backlight source 2 is set to twice the frame period. The vertical direction of FIG. 28 indicates a vertical line direction along which the displaying selection signal is scanned on the display section 1. The horizontal direction of FIG. 28 indicates the time.

In the example illustrated in FIG. 28, the displaying selection signal, reset signal and reading out signal are scanned in a period of ½ of the frame period. In other words, the displaying selection signal, reset signal and reading out signal are supplied to all of the pixels 11 of the display section 1 in the order of lines.

Further, in the example illustrated in FIG. 28, the backlight source 2 blinks in a period equal to twice the frame period. In this instance, the period within which the backlight source 2 is on and emits light is equal in length to the frame period, and the period within which the backlight source 2 is off and emits no light is equal in length to the frame period.

At the starting time of a frame period of a first frame, scanning of the displaying selection signal for displaying an image of a first frame is started. The scanning of the displaying selection signal is ended at a point of time when ½ of the frame period of the first frame elapses. At the point of time at which ½ of the frame period of the first frame elapses, the backlight source 2 which has been on and emitted light is turned off to stop the emission of light and scanning of the reset signal is started.

At the ending time of the frame period of the first frame (starting time of a frame period of a second frame), scanning of the reading out signal is started. The scanning of the reading out signal is ended at a point of time when ½ the frame period of the second frame elapses. Further, at the point of time at which ½ of the frame period of the second frame elapses, the backlight source 2 which has been off and emitted no light is turned on to emit light.

At the point of time at which ½ of the frame period of the second frame elapses, scanning of the displaying selection signal for displaying an image of the second frame is started and scanning of the reset signal is started.

At the starting time of the frame period of a third frame (ending time of the frame period of the second frame), scanning of the displaying control signal for displaying an image of the third frame is started and scanning of the reading out signal is started.

At the point of time at which ½ of the frame period of the third frame elapses, scanning of the displaying selection signal and scanning of the reading out signal are ended, and the backlight source 2 which has been on and emitted light is turned off to stop the emission of light, and scanning of the reset signal is started.

At the ending time of the frame period of the third frame (starting time of a frame period of a fourth frame), scanning of the reading out signal is started. The scanning of the reading out signal is ended at a point of time when ½ of the frame period of the fourth frame elapses. Further, at the point of time at which ½ of the frame period of the fourth frame elapses, the backlight source 2 which has been off and emitted no light is turned on to emit light.

In summary, the backlight source 2 emits light within a period from the starting point of an odd-numbered frame to the point of time at which ½ of the frame period of the odd-numbered frame elapses, and the backlight source 2 emits no light within another period from the point of time at which ½ of the frame period of the odd-numbered frame elapses to the point of time at which ½ of a frame period of a next even-numbered frame elapses. Then, the backlight source 2 emits light within a further period from the point of time at which ½ of the frame period of the odd-numbered frame elapses to the ending time of the odd-numbered frame.

At the starting point of time of an odd-numbered frame, scanning of the displaying selection signal is started and scanning of the reading out signal is started. At the point of time at which ½ of the frame period of the odd-numbered frame elapses, scanning of the reading out signal is started. Then at the starting point of time of a next even-numbered frame, scanning of the reading out signal is started. At the point of time when ½ of the frame period of the even-numbered frame elapses, scanning of the displaying selection signal is started and scanning of the reset signal is started.

In other words, the backlight source 2 blinks in a period equal to twice the frame period, and at a point of time when emission of light from the backlight source 2 is started, scanning of the displaying control signal is started, and then at a point of time at which ½ of the period within which the backlight source 2 emits light elapses, scanning of the displaying selection signal is started. Further, at the point of time at which the backlight source 2 is turned on to emit light (point of time at which emission of light is started) (at the beginning of the period within which light is emitted) or at the point of time at which the backlight source 2 is turned off to stop emission of light (at the beginning of the period within which the backlight source 2 emits no light), scanning of the reset signal is started. At the point of time at which ½ of the period within which the backlight source 2 emits light elapses or at the point of time at which ½ of the period within which the backlight source 2 emits no light elapses, scanning of the reading out signal is started.

Thus, when an image of one frame is displayed, the display times of the lines of the display section 1 are equal to each other in length.

Further, in the third embodiment of the present invention, it is possible to further increase the length of the time required for scanning. For example, where the frame period is set to 1/60 second, the time required for scanning of the displaying selection signal and for scanning of the reset signal and the reading out signal can be set to 1/120 second. In this instance, a period of time of 1/30 second is required in order to acquire a light reception signal representative of the amount of light received within a period within which the backlight source 2 is on and emits light and a reception light signal representative of the amount of light received within a period within which the backlight source 2 is off and emits no light.

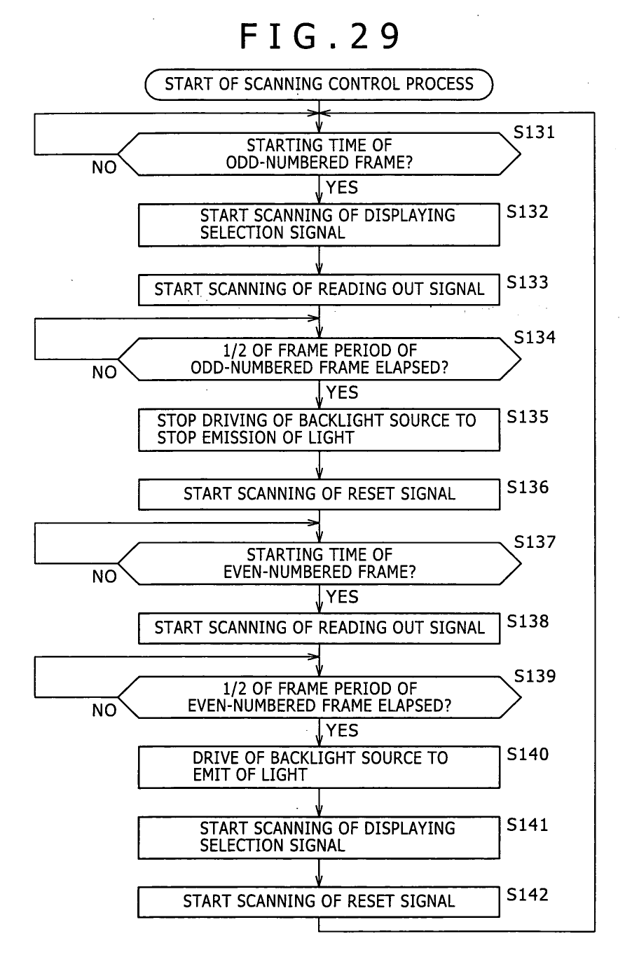

Now, a scanning control process according to the third embodiment of the present invention is described with reference to FIG. 29. At step S131, the display signal retention control section 22 decides based on the display signal supplied thereto from the display signal production section 21 whether or not a starting point of time of an odd-numbered frame comes. If it is decided that a starting point of time of an odd-numbered frame does not come, then the decision process at step S131 is repeated until a starting point of time of an odd-numbered frame comes.

If it is decided at step S131 that a starting point of time of an odd-numbered frame comes, then the processing advances to step S132. At step S132, the display control section 51 of the display signal retention control section 22 controls the display side scanner 24 to start scanning of the displaying selection signal to the display section 1. At step S133, the light reception control section 31 controls the light reception side scanner 32 based on the signal from the display signal retention control section 22 to start scanning of the reading out signal which is a light receiving selection signal for outputting a reception light signal to be used for detection of presence of an object which is in contact with or in the proximity of the display section 1 to the display section 1.

At step S134, the lighting control section 52 decides whether or not ½ of the frame period of the odd-numbered frame elapses. If it is decided that ½ of the frame period of the odd-numbered frame does no elapse, then the decision process at step S134 is repeated until ½ of the frame period of the odd-numbered frame elapses.

If it is decided at step S134 that ½ of the frame period of the odd-numbered frame elapses, then the processing advances to step S135, at which the lighting control section 52 turns off the backlight source 2 to stop emission of light. At step S136, the light reception control section 31 controls the light reception side scanner 32 based on the signal received from the display signal retention control section 22 to start scanning of the reset signal which is a light receiving selection signal to be used for resetting of the light reception cells CR to the display section 1.

At step S137, the display signal retention control section 22 decides based on the display signal supplied thereto from the display signal production section 21 whether or not a starting point of time of a next even-numbered frame comes. If it is decided that a starting point of time of a next even-numbered frame does not come, then the decision process at step S137 is repeated until a starting point of time of a next even-numbered frame comes.

If it is decided at step S137 that a starting point of time of a next even-numbered frame comes, then the processing advances to step S138. At step S138, the light reception control section 31 controls the light reception side scanner 32 to start scanning of the reading out signal based on the signal from the display signal retention control section 22.

At step S139, the lighting control section 52 decides whether or not ½ of the frame period of the even-numbered frame elapses. If it is decided that ½ of the frame period of the even-numbered frame does not elapse, then the decision process at step S139 is repeated until ½ of the frame period of the even-numbered frame elapses.

If it is decided at step S139 that ½ of the frame period of the even-numbered frame elapses, then the processing advances to step S140, at which the lighting control section 52 controls the backlight source 2 to emit light. At step S141, the display control section 51 controls the display side scanner 24 to start scanning of the displaying selection signal to the display section 1.

At step S142, the light reception control section 31 controls the light reception side scanner 32 based on the signal from the display signal retention control section 22 to start scanning of the reset signal. Thereafter, the processing returns to step S142 to repeat the processes described above.

Since the backlight source 2 is turned off to stop emission of light and scanning of the reset signal is started at a point of time at which ½ of the frame period of an odd-numbered frame elapses and then scanning of the reading out signal is started at the starting point of time of a next even-numbered frame in this manner, scanning of the reading out signal from the entire display section 1 is completed within a period within which the backlight source 2 is off and emits no light. Further, since the backlight source 2 is turned on to emit light and scanning of the reset signal is started at a point of time at which ½ of the frame period of the even-numbered frame elapses and scanning of the reading out signal is started at the starting point of time of another odd-numbered frame, scanning of the reading out signal from the entire display section 1 is completed within a period within which the backlight source 2 is on and emits light. From the reception light signal obtained in this manner, presence of an object which is in contact with or in the proximity of the display section 1 or the position of an object which is in contact with or in the proximity of the display section 1 can be detected with a higher degree of accuracy without being influenced by the intensity of external light.

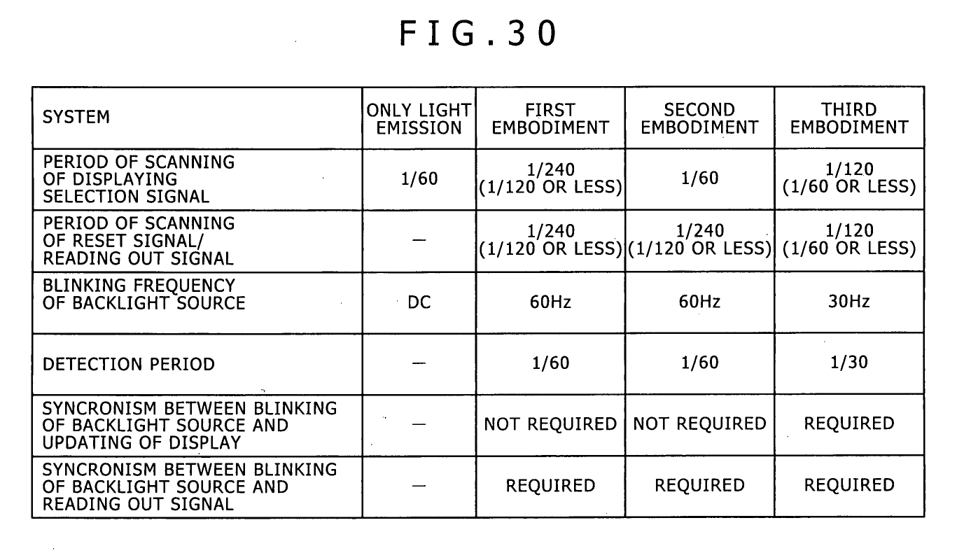

FIG. 30 illustrates differences among the first to third embodiments described hereinabove. The unit of any numerical value for which no unit is specified in FIG. 30 is second.

For comparison, it is illustrated in FIG. 30 that, when presence of an object which is in contact with or in the proximity of the display section 1 is not detected, the period of the displaying control signal is 1/60 second and the blinking frequency of the backlight source 2 is 0 Hz (indicated by DC (direct current) in FIG. 30.

First, a case is described wherein 60 frames are displayed for one second in the first embodiment. In this instance, the period of the displaying control signal is, for example, 1/240 second and can be set to 1/120 or less. The period of the reset signal and the reading out signal is, for example, 1/240 second and can be set to 1/120 or less. Further, the blinking frequency of the backlight source 2 is 60 Hz.

Since presence of an object which is in contact with or in the proximity of the display section 1 is detected from a reception light signal within a period within which the backlight source 2 is on and emits light and another reception light signal within another period within which the backlight source 2 is off and emits no light, the period of detection is 1/60 second.

Further, in this instance, although synchronism between blinking of the backlight source 2 and updating of the display of the display section 1 is unnecessary, synchronism between blinking of the backlight source 2 and the reading out signal is required.

Now, a case is described wherein 60 frames are displayed for one period in the second embodiment. In this instance, the period of the displaying selection signal is 1/60 second. The period of the reset signal and the reading out signal is, for example, 1/240 second and can be set to 1/120 second or less. Further, the blinking frequency of the backlight source 2 is 60 Hz. The period of detection is 1/60 second.

Further, in the case of the second embodiment, although synchronism between blinking of the backlight source 2 and updating of the display of the display section 1 is unnecessary, synchronism between blinking of the backlight source 2 and the reading out signal is required.

Furthermore, a case is described wherein 60 frames are displayed for one second in the third embodiment. In this instance, the period of the displaying selection signal is, for example, 1/120 second and can be set to 1/60 second or less. The period of the reset signal and the reading out signal is, for example, 1/120 second and can be set to 1/60 second or less. Further, the blinking frequency of the backlight source 2 is 30 Hz. The period of detection is 1/30 second.

In the case of the third embodiment, synchronism between blinking of the backlight source 2 and updating of the display of the display section 1 is required, and in addition, synchronism between blinking of the backlight source 2 and updating of the display of the display section 1 is required.

Now, a fourth embodiment of the present invention is described with reference to FIGS. 31 to 33. In the fourth embodiment of the present invention, when the display is updated, the display section 1 is divided into a plurality of regions each of which includes pixels whose display is updated at points of time near to each other, and light is illuminated from the backlight source 2 for each of the divisional regions of the display section 1.

FIG. 31 shows six backlight sources provided for one display section 1. In the example shown in FIG. 31, the single display section 1 includes backlight sources 101-1 to 101-6, which emit light independently of each other and each illuminates the light upon one of the regions which has an area of ⅙ of the entire area of the display section 1 and basically does not overlap with any other region. Each of the backlight sources 101-1 to 101-6 is formed from an LED, an organic or inorganic EL element, a cold-cathode tube, or the like.

For example, where the displaying selection signal is scanned in a vertical line direction of the display section 1, the backlight sources 101-1 to 101-6 are divided by horizontal lines with reference to an upper end of the display section 1. More particularly, the backlight source 101-1 emits light so as to irradiate the light in the first region from above of the display section 1, and the backlight source 101-2 emits light so as to irradiate the light in the second region from above of the display section 1. Similarly, the backlight source 101-3 emits light so as to irradiate the light in the third region from above of the display section 1, and the backlight source 101-4 emits light so as to irradiate the light in the fourth region from above of the display section 1. Further, the backlight source 101-5 emits light so as to irradiate the light in the fifth region from above of the display section 1, and the backlight source 101-6 emits light so as to irradiate the light in the lowermost region of the display section 1.

If the displaying selection signal is scanned, then the backlight sources 101-1 to 101-6 blink so as to emit light in order in synchronism with the scanning of the displaying selection signal.

It is to be noted that, while the six backlight sources 101-1 to 101-6 are provided in the example described above, the number of backlight sources is not limited to 6, but may be any arbitrary number. Or, the light emitting region of one backlight source may be divided into a plurality of light emitting regions.

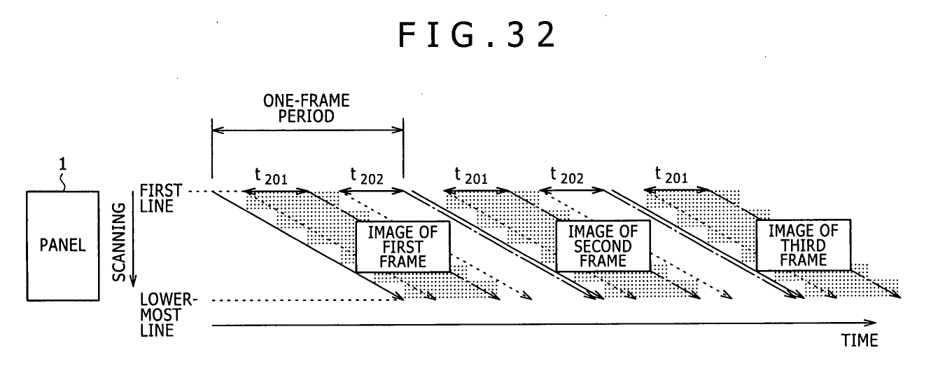

FIG. 32 illustrates scanning of the displaying selection signal, reset signal and reading out signal where light is irradiated from the backlight sources 101-1 to 101-6 on the individual regions of the display section 1. The vertical direction of FIG. 32 indicates a vertical line direction along which the displaying selection signal is scanned on the display section 1. To the uppermost line (line formed from pixels juxtaposed in a row along a horizontal line direction) of the display section 1, the displaying selection signal is supplied first in scanning of the displaying selection signal, and to the lowermost line (line on the lowermost state in FIG. 32) of the display section 1, the displaying selection signal is supplied at the last in scanning of the displaying selection signal. The horizontal direction of FIG. 32 indicates the time.

At the point of time at which a frame period is started, scanning of the displaying selection signal is started. If the displaying selection signal is supplied to the entire region upon which light is irradiated from the backlight source 101-1, that is, if the display of the region upon which light is irradiated from the backlight source 101-1 is updated, then the backlight source 101-1 which has been off and emitted no light is turned on to emit light. Consequently, the light is irradiated on the region of the display section 1 whose display has been updated. If the displaying selection signal is supplied to the entire region upon which light is irradiated from the backlight source 101-2, that is, if the display of the region upon which light is irradiated from the backlight source 101-2 is updated, then the backlight source 101-2 which has been off and emitted no light is turned on to emit light. Consequently, the light is irradiated on the region of the display section 1 whose display has been updated.

Similarly, if the displaying selection signal is supplied to the entire regions upon which light is irradiated from the backlight sources 101-3 to 101-6, that is, if the displays of the regions upon which light is irradiated from the backlight sources 101-3 to 101-6 are updated, then the backlight sources 101-3 to 101-6 which have been off and emitted no light are turned on to emit light individually. Consequently, the light is irradiated on the respective regions of the display section 1 whose display has been updated.

In this manner, the backlight sources 101-1 to 101-6 individually emit light in order in synchronism with scanning of the displaying control signal to the display section 1.

When the backlight source 101-1 emits light, scanning of the reset signal is started. The time required for scanning of the reset signal to the entire display section 1 is equal to the time required for scanning of the displaying selection signal to the entire display section 1. Accordingly, when the backlight source 101-2 emits light, scanning of the reset signal to the region of the display section 1 upon which light is irradiated from the backlight source 101-2 is started. Similarly, when the backlight sources 101-3 to 101-6 successively emit light, scanning of the reset signal to the regions of the display section 1 which are irradiated from the backlight sources 101-3 to 101-6 is started, respectively.

At the point of time when a period t201 elapses after scanning of the reset signal is started, scanning of the reading out signal is started. The time required for scanning of the reading out signal to the entire display section 1 is equal to the time required for scanning of the reset signal or the displaying selection signal to the entire display section 1.

When the reading out signal is supplied to the entire region upon which light is irradiated from the backlight source 101-1, the backlight source 101-1 which has been on and emitted light is turned off and stops the emission of light. When the reading out signal is supplied to the entire region upon which light is irradiated from the backlight source 101-2, the backlight source 101-2 which has been on and emitted light is turned off and stops the emission of light.

Similarly, when the reading out signal is successively supplied to the entire regions upon which light is irradiated from the backlight sources 101-3 to 101-6, the backlight sources 101-3 to 101-6 which have been on and emitted light are successively turned off and stop the emission of light.

In this manner, the backlight sources 101-1 to 101-6 are individually turned off to stop emission of light in order in synchronism with scanning of the reading out signal to the display section 1.

When the backlight source 101-1 is turned off to stop emission of light, scanning of the reset signal is started. Since the time required for scanning of the reset signal to the entire display section 1 is equal to the time required for scanning of the reading out signal to the entire display section 1, when the backlight sources 101-2 to 101-6 are successively turned off to stop emission of light, scanning of the reset signal to the regions of the display section 1 upon which light is irradiated from the backlight sources 101-2 to 101-6 is started, respectively.

At the point of time at which a period t202 elapses (for example, at the time at which a frame period ends) after scanning of the reset signal is started, scanning of the reading out signal is started.

In this manner, the display section 1 is divided into a plurality of regions each of which includes pixels whose display is updated at points of time near to each other, and light is irradiated from the backlight sources 101-1 to 101-6 for the individual divided regions of the display section 1. Then, the reset signal and the reading out signal are scanned in synchronism with the irradiation of light from the backlight sources 101-1 to 101-6 upon the individual regions.

By the configuration described above, the period of time after scanning of the reset signal is started until scanning of the reading out signal is started can be set to a longer period.

For example, where the time required for scanning of the displaying selection signal, reset signal or reading out signal to the entire display section 1 is 1/60 second and equal to the frame period, since the time required for scanning of one region of the display section 1 which is divided into six regions is 1/360 second, both of the period t201 and the period t202 can be set to (frame period−(time from the starting time of the frame to the time at which scanning of the reset signal is started)−(time after scanning of the first reading out signal is started until the scanning of the second reset signal is started))/2, that is, ( 1/60− 1/360− 1/360)/2= 1/180 second.

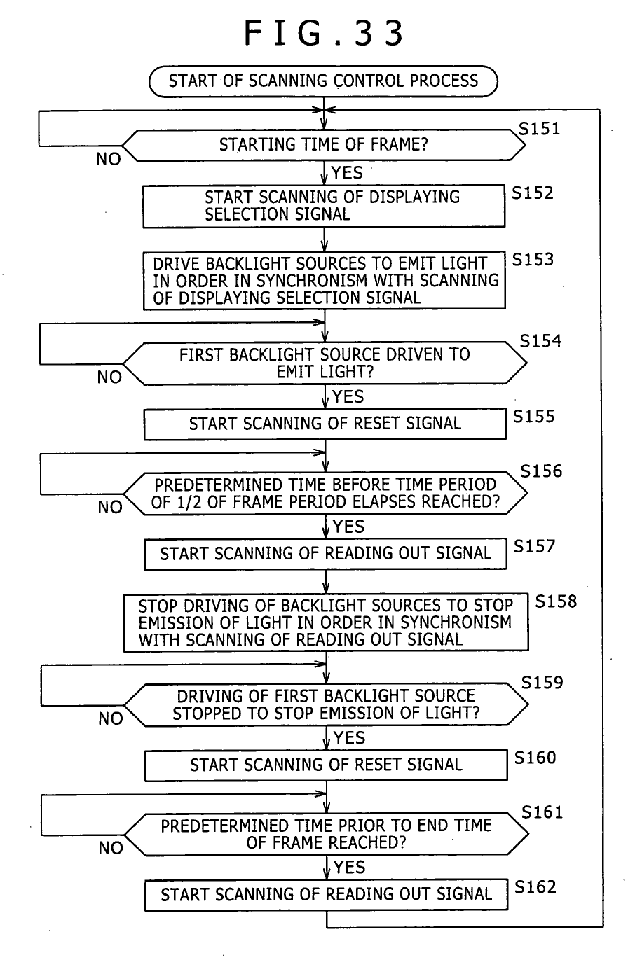

Now, a scanning control process where light is illuminated on a plurality of regions each including pixels whose display is updated at times near to each other from the backlight sources 101-1 to 101-6 is described with reference to a flow chart of FIG. 33.

At step S151, the display signal retention control section 22 decides based on the display signal supplied thereto from the display signal production section 21 whether or not starting time of a frame comes. If it is decided that starting time of a frame does not come, then the decision process at step S151 is repeated until starting time of a frame comes.

If it is decided at step S151 that starting time of a frame comes, then the processing advances to step S152, at which the display control section 51 of the display signal retention control section 22 controls the display side scanner 24 to start scanning of the displaying selection signal to the display section 1. At step S153, the lighting control section 52 of the display signal retention control section 22 controls the backlight sources 101-1 to 101-6 to successively emit light in order in synchronism with scanning of the displaying selection signal.

At step S154, the light reception control section 31 decides based on the signal from the display signal retention control section 22 whether or not the backlight source 101-1 which is the first backlight source is turned on to emit light. If it is decided that the backlight source 101-1 which is the first backlight source is not turned on and does not emit light, then the processing returns to step S154. Consequently, the decision process is repeated until the backlight source 101-1 which is the first backlight source is turned on to emit light.

If it is decided at step S154 that the backlight source 101-1 which is the first backlight source is turned on to emit light, then the processing advances to step S155. At step S155, the light reception control section 31 controls the light reception side scanner 32 to start scanning of the resent signal which is a light receiving selection signal used to reset the light reception cells CR to the display section 1.

At step S156, the light reception control section 31 decides whether or not predetermined time comes which is time before a time period of ½ of the frame period elapses. If it is decided that the predetermined time does not come which is time before a time period of ½ of the frame period elapses, then the processing returns to step S156 to repeat the decision process.

If it is decided at step S156 that the predetermined time comes which is time before a time period of ½ of the frame period elapses, the processing advances to step S157. At step S157, the light reception control section 31 controls the light reception side scanner 32 to start scanning of the reading out signal which is a light receiving selection signal for outputting a reception light signal to be used for detection of presence of an object which is in contact with or in the proximity of the display section 1 to the display section 1.

At step S158, the lighting control section 52 of the display signal retention control section 22 turns off the backlight sources 101-1 to 101-6 to stop the emission of light in order in synchronism with scanning of the reading out signal based on the signal from the light reception control section 31.

At step S159, the light reception control section 31 decides based on the signal from the display signal retention control section 22 whether or not the backlight source 101-1 which is the first backlight source is turned off to stop emission of light. If it is decided that the backlight source 101-1 which is the first backlight source is not turned off to stop emission of light, then the processing returns to step S159. Consequently, the decision process is repeated until the backlight source 101-1 which is the first backlight source is turned off to stop emission of light.

If it is decided at step S159 that the backlight source 101-1 which is the first backlight source is turned off to stop emission of light, then the processing advances to step S160. At step S160, the light reception control section 31 controls the light reception side scanner 32 to start scanning of the reset signal to the display section 1.

At step S161, the light reception control section 31 decides whether or not predetermined time comes which is time prior to the ending time of the frame. If it is decided that the predetermined time does not come which is time prior to the ending time of the frame, then the processing returns to step S161 to repeat the decision process.

If it is decided at step S161 that the predetermined time comes which is time prior to the ending time of the frame, then the processing advances to step S162. At step S162, the light reception control section 31 controls the light reception side scanner 32 to start scanning of the reading out signal which is a light receiving selection signal to the display section 1. Thereafter, the processing returns to step S151 to repeat the processes described above.

As described above, light is irradiated from the backlight sources 101-1 to 101-6 individually on the divisional regions of the display section 1, and the reset signal and the reading out signal are scanned in the regions in synchronism with the irradiation of the light from the backlight sources 101-1 to 101-6 upon the regions. By the configuration just described, even if the time required for scanning of the displaying selection signal, reset signal or reading out signal is set shorter, the period of time after scanning of the reset signal is started until scanning of the reading out signal is started with respect to the frame period can be increased.

Accordingly, even if the sensitivity of the light reception cells CR is low, the position of an object or the like can be detected with a high degree of certainty by a simple structure while assuring the convenience without reducing the time required for scanning of the displaying selection signal, reset signal or reading out signal and without deteriorating the picture quality.

In this manner, according to the present invention, presence of an object which is in contact with or in the proximity of the display section 1 or the position of an object which is in contact with or in the proximity of the display section 1 can be detected with the influence of external light removed. According to the present invention, the necessity to externally attach a part for position detection such as a touch panel is eliminated, and the number of parts can be reduced accordingly. Further, since an image to be displayed is not formed through a layer for position detection (since the user does not look at an image through a layer for position detection), deterioration of an image recognized by the user can be prevented.

Further, if an image being displayed is updated within a period within which no light is emitted, then an after-image which may be recognized from a displayed image can be reduced.

As described above, according to the present invention, the accumulation time (exposure time) of the light reception cells CR can be increased to alternately read out a reception light signal within a period within which light is emitted and another reception light signal within another period within which no light is emitted without making the period for re-writing of a display shorter and without making the time required for scanning of the displaying selection signal, reset signal or reading out signal shorter.

Depending upon the reception light signals, it is possible to detect presence of an object which is in contact with or in the proximity of the display section 1 or the position of an object which is in contact with or in the proximity of the display section 1 with a higher degree of accuracy with a simple structure without deteriorating the picture quality while the convenience is assured.

In this manner, where display elements for displaying an image and light receiving elements provided corresponding to the individual display elements are disposed on a screen, it is possible to display an image and detect the position of an object. Further, if light emission of the display elements is controlled while light reception by the light receiving elements is controlled such that the amount of light incoming to all of the light receiving elements within one light emission period within which the display elements emit light and the amount of light incoming to all of the light receiving elements is acquired within one no-light emission period within which the display element emits no light, then presence of an object which is in contact with or in the proximity of the display section 1 or the position of an object which is in contact with or in the proximity of the display section 1 can be detected with a higher degree of accuracy with a simple structure without deteriorating the picture quality while the convenience is assured.

It is to be noted that, while it is described in the foregoing description that the decision processes described above are executed by one of the display signal retention control section 22 and the light reception control section 31, they may otherwise be executed by the display signal retention control section 22 such that a notification of a result of the decision is conveyed to the light reception control section 31.

Further, while it is described that a reception light signal while the backlight source 2 exhibits no light is subtracted from a reception light signal while the backlight source 2 emits light, the brightness of an image being displayed may be taken into consideration such that the reception light signals are weighted in accordance with the brightness of the image being displayed and then the subtraction is performed between the resulting weighted reception light signals.

Further, while it is described that a reception light signal while the backlight source 2 exhibits no light is subtracted from a reception light signal while the backlight source 2 emits light by the position detection section 35, a mechanism for retaining a reception light signal such as a capacitor and another mechanism for performing signal changeover such as a switch may be provided in the inside of each pixel 11 such that the subtraction is performed in the inside of the pixel 11 and a signal after the arithmetic operation is received by the reception light signal receiver 33.

Further, while it is described in the foregoing description that one display cell CW and one light reception cell CR are provided in each of the pixels 11, the pixel 11 may be modified such that it has a structure in which a display cell and a reception light cell are provided but not in a one-by-one relationship (one to multiple or multiple to one) such that a plurality of light reception cells CR are provided for one display cell CW or one light reception cell CR is provided for a plurality of display cells CW.

It is to be noted that the light receiving element PD is not limited to a photodiode but may be any element only if it can detect the intensity of light. In particular, the light receiving element PD may be formed from a phototransistor, a CMOS (Complementary Metal-Oxide Semiconductor) sensor or the like, and the entire light reception cell CR may be formed from a CCD (Charge Coupled Device).

While the series of processes described above can be executed by hardware, it may otherwise be executed by software. Where the series of processes is executed by software, a program which constructs the software is installed from a recording medium into a computer incorporated in hardware for exclusive use or, for example, a general purpose personal computer which can execute various functions by installing various programs.

The recording medium may be formed as a package medium such as, as shown in FIG. 1, a magnetic disc 61 (including a flexible disc), an optical disc 62 (including a CD-ROM (Compact Disc-Read Only Memory) and a DVD (Digital Versatile Disc)), or a magneto-optical disc 63 (including an MD (Mini Disc) (trademark)), or a semiconductor memory 64 which has the program recorded thereon or therein and is distributed to provide the program to a user separately from an apparatus body. Else, the recording medium is formed as a ROM (not shown), a hard disc or the like in which the program is stored and which is provided to a user in a state wherein the program is incorporated in a computer in advance.

It is to be noted that the program for causing the series of processes described above to be executed may be installed into a computer through a wired or wireless communication medium such as a local area network, the Internet or a digital satellite broadcast through an interface such as a router or a modem as occasion demands.

Further, in the present specification, the steps which describe the program recorded in a recording medium may be but need not necessarily be processed in a time series in the order as described, and include processes which are executed in parallel or individually without being processed in a time series.

While preferred embodiments of the present invention has been described using specific terms, such description is for illustrative purposes only, and it is to be understood that changes and variations may be made without departing from the spirit or scope of the following claims.

What is claimed is:

1. An inputting/outputting apparatus wherein a plurality of display elements for displaying an image in a predetermined number of frames per unit time and a plurality of light receiving elements individually provided corresponding to said display elements are arranged on a screen, comprising:
a light emission control section for controlling emission of light of said display elements so that said display elements blink by a number of times per unit time which corresponds to the number of frames per unit time; and
a light reception control section for controlling reception of light by said light receiving elements so that the amount of light incoming to all of said light receiving elements within one light emission period within which said display elements emit light is acquired and the amount of light incoming to all of said light receiving elements within one no-light emission period within which said display elements emit no light is acquired.

2. The inputting/outputting apparatus according to claim 1, wherein said light emission control section controls emission of light of a backlight to control the emission of light of said display elements.

3. The inputting/outputting apparatus according to claim 1, wherein said light emission control section controls emission of light of a plurality of backlights disposed in accordance with an order of operation of said display elements which operate line sequentially on said screen so that said backlights are turned on to emit light to control the emission of light of said display section.

4. The inputting/outputting apparatus according to claim 1, wherein said light reception control section controls starting of resetting or starting of reading out of a signal from said light reception elements which operate line sequentially on said screen.

5. The inputting/outputting apparatus according to claim 1, wherein said light emission control section controls the emission of light of said display elements in synchronism with the frame.

6. The inputting/outputting apparatus according to claim 1, further comprising a display control section for controlling the display by said display elements so that the display of said display element is updated only within a light emission period within which said display elements emit light.

7. An inputting/outputting method for an inputting/outputting apparatus wherein a plurality of display elements for displaying an image in a predetermined number of frames per unit time and a plurality of light receiving elements individually provided corresponding to said display elements are arranged on a screen, comprising:
a light emission control step of controlling emission of light of said display elements so that said display elements blink by a number of times per unit time which corresponds to the number of frames per unit time; and
a light reception control step of controlling reception of light by said light receiving elements so that the amount of light incoming to all of said light receiving elements within one light emission period within which said display elements emit light is acquired and the amount of light incoming to all of said light receiving elements within one no-light emission period within which said display elements emit no light is acquired.

8. A recording medium on which a computer-readable program for an inputting/outputting process of an inputting/outputting apparatus wherein a plurality of display elements for displaying an image in a predetermined number of frames per unit time and a plurality of light receiving elements individually provided corresponding to said display elements are arranged on a screen is recorded, said program comprising:
a light emission control step of controlling emission of light of said display elements so that said display elements blink by a number of times per unit time which corresponds to the number of frames per unit time; and
a light reception control step of controlling reception of light by said light receiving elements so that the amount of light incoming to all of said light receiving elements within one light emission period within which said display elements emit light is acquired and the amount of light incoming to all of said light receiving elements within one no-light emission period within which said display elements emit no light is acquired.

9. A program for causing a computer of an inputting/outputting apparatus wherein a plurality of display elements for displaying an image in a predetermined number of frames per unit time and a plurality of light receiving elements individually provided corresponding to said display elements are arranged on a screen to execute an inputting/outputting process, comprising:
a light emission control step of controlling emission of light of said display elements so that said display elements blink by a number of times per unit time which corresponds to the number of frames per unit time; and
a light reception control step of controlling reception of light by said light receiving elements so that the amount of light incoming to all of said light receiving elements within one light emission period within which said display elements emit light is acquired and the amount of light incoming to all of said light receiving elements within one no-light emission period within which said display elements emit no light is acquired.
